(19) United States
(12) Patent Application Publication
(10) Pub. No.: US 2018/0046979 A1
(43) Pub. Date: Feb. 15, 2018

(54) Self-Addressed Parcel Tracking Devices and Methods

(71) Applicant: BOT Home Automation, Inc., Santa Monica, CA (US)

(72) Inventor: James Siminoff, Pacific Palisades, CA (US)

(21) Appl. No.: 15/669,606

(22) Filed: Aug. 4, 2017

Related U.S. Application Data
(60) Provisional application No. 62/374,505, filed on Aug. 12, 2016.
(60) Provisional application No. 62/450,767, filed on Jan. 26, 2017.

(51) Int. Cl. G06Q 10/08; G01S 19/24

(52) U.S. Cl. CPC G06Q 10/0833; G01S 19/24; G06Q 10/0837

(57) ABSTRACT

A self-addressed parcel tracking device comprises a housing; a wireless communication module located at least partially within the housing; a processing module located at least partially within the housing and communicatively coupled to the wireless communication module; a power source located at least partially within the housing and electrically coupled to the wireless communication module and the processing module; and a mailing address of an originator of a parcel. The mailing address is on an exterior surface of the housing, and configured to enable a recipient of the parcel to return the self-addressed tracking device to the originator of the parcel.

### CROSS-REFERENCE TO RELATED APPLICATIONS

This application claims priority to provisional application Ser. No. 62/450,767, filed on Jan. 26, 2017, and provisional application Ser. No. 62/374,505, filed on Aug. 12, 2016. The entire contents of the priority applications are hereby incorporated by reference as if fully set forth.

### TECHNICAL FIELD

The present embodiments relate to protecting parcels from theft. In particular, the present embodiments solve several problems, including the propensity for parcels left in plain view to be stolen, and the prohibitive cost associated with placing a tracking device in every parcel. Some of the present embodiments leverage the capabilities of audio/video (A/V) recording and communication devices, including A/V recording and communication doorbells, to protect parcels from theft.

### BACKGROUND

Home safety is a concern for many homeowners and renters. Those seeking to protect or monitor their homes often wish to have video and audio communications with visitors, for example, those visiting an external door or entryway. Audio/Video (A/V) recording and communication doorbell systems provide this functionality, and can also aid in crime detection and prevention. For example, audio and/or video captured by an A/V recording and communication doorbell can be uploaded to the cloud and recorded on a remote server. Subsequent review of the A/V footage can aid law enforcement in capturing perpetrators of home burglaries and other crimes. Further, the presence of an A/V recording and communication doorbell at the entrance to a home acts as a powerful deterrent against would-be burglars.

### SUMMARY

The various embodiments of the present self-addressed parcel tracking devices and methods have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that parcel theft is a serious problem. Parcel carriers frequently leave parcels near the front door of a home when no one answers the door at the time of delivery. These parcels are vulnerable to theft, as they are often clearly visible from the street. This problem has only gotten worse with the proliferation of online commerce, and is particularly common around major holidays when many consumers do their holiday shopping online. It would be advantageous, therefore, if parcels could be configured in a way that would discourage people from attempting to steal them.

One way to discourage people from attempting to steal parcels would be to place a tracking device in every parcel. A tracking device is a device that enables the location of the device to be determined and tracked from a location remote from the tracking device. If every parcel contained a tracking device, then it would be possible to locate, track, and recover stolen parcels, making parcels much less attractive to thieves. Placing a tracking device in every parcel, however, could be cost prohibitive, because of the added cost of the tracking device itself. When a parcel recipient receives a parcel, he or she typically removes the contents from the parcel container and then discards the container and any packing materials that may have been included to keep the parcel contents safe during transit. If the parcel contained a tracking device, it too would likely be discarded, leaving the shipping entity to bear the cost of the discarded tracking device. The cost associated with discarded tracking devices might be passed on to the consumer, but, regardless of which party (sender or recipient) bears the cost for discarded tracking devices, this scenario would substantially increase the cost for shipping goods, and is therefore likely not feasible.

The present embodiments solve this problem by providing parcel tracking devices that are self-addressed. The parcel tracking device bears an address, such as the address of the originating entity, and may in some embodiments also include postage or an indicator that postage for the return of the tracking device will be paid by the addressee. The recipient of the parcel thus needs only to place the self-addressed tracking device in any mailbox, and the tracking device will be returned to the originating entity. The originating entity can then reuse the self-addressed tracking device, thereby significantly lowering the cost of placing tracking devices in parcels. In some embodiments, the present self-addressed tracking devices may be included in every parcel. In other embodiments, the present self-addressed tracking devices may be included in only select parcels, such as a subset of a larger group of parcels. The subset of parcels may comprise, for example, only parcels associated with recipients who have requested that a self-addressed tracking device be included with their parcel. In another example, the parcel originator may include a self-addressed tracking device in every other parcel, or every third parcel, or every fourth parcel, or every fifth parcel, or at any other regular interval. In another example, the parcel originator may add self-addressed tracking devices to parcels according to a random process.

Some of the present embodiments also leverage the functionality of A/V recording and communication devices to deter parcel theft and/or to identify and apprehend parcel thieves. For example, in some embodiments an A/V recording and communication device may receive a first wireless transmission from a tracking device of a parcel. The A/V recording and communication device may then determine, based on the receipt of the first wireless transmission, that the parcel has been left near the location of the A/V recording and communication device. The A/V recording and communication device may subsequently receive a second wireless transmission from the tracking device of the parcel. The A/V recording and communication device may then determine, based on the receipt of the second wireless transmission, that the parcel has been removed from near the location of the A/V recording and communication device. The A/V recording and communication device may then determine whether the removal of the parcel was authorized and, if the removal was unauthorized, the A/V recording and communication device may generate an alert, such as an alert to a user's smartphone (or other type of client device).

In a first aspect, a parcel assembly is provided, the parcel assembly comprising: a container; parcel contents within the container; and a self-addressed tracking device within the container, wherein the self-addressed tracking device includes a housing; a wireless communication module located at least partially within the housing; a processing module located at least partially within the housing and communicatively coupled to the wireless communication module; a power source located at least partially within the housing and electrically coupled to the wireless communication module and the processing module; and a mailing address of an originator of the parcel assembly, the mailing address being on an exterior surface of the housing, and being configured to enable a recipient of the parcel assembly to return the self-addressed tracking device to the originator of the parcel assembly.

In an embodiment of the first aspect, the self-addressed tracking device further comprises an indicator on the exterior surface of the housing that postage for returning the self-addressed tracking device to the originator will be paid by the addressee.

In another embodiment of the first aspect, the addressee is the originator of the parcel assembly.

In another embodiment of the first aspect, the self-addressed tracking device further comprises postage on the exterior surface of the housing.

In another embodiment of the first aspect, the self-addressed tracking device further comprises an indicator on the exterior surface of the housing to return the self-addressed tracking device by depositing it in any mailbox.

In another embodiment of the first aspect, the container comprises a box, a carton, a crate, an envelope, or a pouch.

In another embodiment of the first aspect, the self-addressed tracking device comprises a satellite navigation system tracking unit.

In another embodiment of the first aspect, the satellite navigation system tracking unit comprises a GPS (Global Positioning System) tracking unit or a GLONASS (Global Navigation Satellite System) tracking unit.

Another embodiment of the first aspect further comprises a notice on an outer surface of the container, wherein the notice indicates that the parcel assembly contains an anti-theft device.

In a second aspect, a self-addressed parcel tracking device is provided, the self-addressed parcel tracking device comprising: a housing; a wireless communication module located at least partially within the housing; a processing module located at least partially within the housing and communicatively coupled to the wireless communication module; a power source located at least partially within the housing and electrically coupled to the wireless communication module and the processing module; and a mailing address of an originator of a parcel, the mailing address being on an exterior surface of the housing, and being configured to enable a recipient of the parcel to return the self-addressed tracking device to the originator of the parcel.

In an embodiment of the second aspect, the self-addressed tracking device further comprises an indicator on the exterior surface of the housing that postage for returning the self-addressed tracking device to the originator will be paid by the addressee.

In another embodiment of the second aspect, the addressee is the originator of the parcel assembly.

In another embodiment of the second aspect, the self-addressed tracking device further comprises postage on the exterior surface of the housing.

In another embodiment of the second aspect, the self-addressed tracking device further comprises an indicator on the exterior surface of the housing to return the self-addressed tracking device by depositing it in any mailbox.

In another embodiment of the second aspect, the self-addressed tracking device comprises a satellite navigation system tracking unit.

In another embodiment of the second aspect, the satellite navigation system tracking unit comprises a GPS (Global Positioning System) tracking unit or a GLONASS (Global Navigation Satellite System) tracking unit.

In a third aspect, a method for protecting a parcel assembly from theft is provided, the method comprising: assembling the parcel assembly by placing parcel contents within a container; and placing a self-addressed tracking device within the container; wherein the self-addressed tracking device includes a housing; a wireless communication module located at least partially within the housing; a processing module located at least partially within the housing and communicatively coupled to the wireless communication module; a power source located at least partially within the housing and electrically coupled to the wireless communication module and the processing module; and a mailing address of an originator of the parcel assembly, the mailing address being on an exterior surface of the housing, and being configured to enable a recipient of the parcel assembly to return the self-addressed tracking device to the originator of the parcel assembly.

In an embodiment of the third aspect, the self-addressed tracking device further comprises an indicator on the exterior surface of the housing that postage for returning the self-addressed tracking device to the originator will be paid by the addressee.

In another embodiment of the third aspect, the addressee is the originator of the parcel assembly.

In another embodiment of the third aspect, the self-addressed tracking device further comprises postage on the exterior surface of the housing.

In another embodiment of the third aspect, the self-addressed tracking device further comprises an indicator on the exterior surface of the housing to return the self-addressed tracking device by depositing it in any mailbox.

In another embodiment of the third aspect, the container comprises a box, a carton, a crate, an envelope, or a pouch.

In another embodiment of the third aspect, the self-addressed tracking device comprises a satellite navigation system tracking unit.

In another embodiment of the third aspect, the satellite navigation system tracking unit comprises a GPS (Global Positioning System) tracking unit or a GLONASS (Global Navigation Satellite System) tracking unit.

Another embodiment of the third aspect further comprises providing a notice on an outer surface of the container, wherein the notice indicates that the parcel assembly contains an anti-theft device.

Another embodiment of the third aspect further comprises receiving, prior to assembling the parcel assembly, a request from the recipient of the parcel assembly to include the self-addressed tracking device within the parcel assembly.

Another embodiment of the third aspect further comprises, in response to receiving the request from the recipient of the parcel assembly to include the self-addressed tracking device within the parcel assembly, receiving a deposit payment from the recipient of the parcel assembly, the deposit payment being refundable when the recipient of the parcel assembly returns the self-addressed tracking device to the originator of the parcel assembly.

In a fourth aspect, a parcel assembly is provided, the parcel assembly comprising: a container; parcel contents within the container; and a tracking device within the container, wherein the tracking device includes a housing; a wireless communication module located at least partially within the housing; a processing module located at least partially within the housing and communicatively coupled to the wireless communication module; and a power source located at least partially within the housing and electrically coupled to the wireless communication module and the processing module; wherein the tracking device is concealed within the container such that the tracking device is not visible when the container is sealed nor when the container is open.

In an embodiment of the fourth aspect, the container comprises a box, a carton, a crate, an envelope, or a pouch.

In another embodiment of the fourth aspect, the self-addressed tracking device comprises a satellite navigation system tracking unit.

In another embodiment of the fourth aspect, the satellite navigation system tracking unit comprises a GPS (Global Positioning System) tracking unit or a GLONASS (Global Navigation Satellite System) tracking unit.

Another embodiment of the fourth aspect further comprises a notice on an outer surface of the container, wherein the notice indicates that the parcel assembly contains an anti-theft device.

Another embodiment of the fourth aspect further comprises at least a second tracking device within the container, wherein the second tracking device is concealed within the container such that the second tracking device is not visible when the container is sealed nor when the container is open.

In a fifth aspect, a method for protecting a parcel assembly from theft is provided, the parcel assembly including a container and a tracking device within the container, the method comprising: receiving, by an audio/video (A/V) recording and communication device, a first wireless transmission from the tracking device of the parcel assembly; determining, by the A/V recording and communication device, based on the receipt of the first wireless transmission, that the parcel assembly has been left within an area about the A/V recording and communication device; receiving, by the A/V recording and communication device, a second wireless transmission from the tracking device of the parcel assembly; determining, by the A/V recording and communication device, based on the receipt of the second wireless transmission, that the parcel assembly has been removed from the area about the A/V recording and communication device; determining, by the A/V recording and communication device, whether removal of the parcel assembly from the area about the A/V recording and communication device was authorized; and when the removal of the parcel assembly from the area about the A/V recording and communication device is determined to have been unauthorized, generating, by the A/V recording and communication device, an alert.

In an embodiment of the fifth aspect, determining whether removal of the parcel assembly from the area about the A/V recording and communication device was authorized comprises determining a direction of movement of the parcel assembly.

In another embodiment of the fifth aspect, the alert comprises a push notification sent to a client device associated with the A/V recording and communication device.

Another embodiment of the fifth aspect further comprises transmitting, by the A/V recording and communication device, the push notification to the client device associated with the A/V recording and communication device.

In another embodiment of the fifth aspect, the alert comprises a notification sent to a device associated with a law enforcement agency.

In another embodiment of the fifth aspect, the A/V recording and communication device is an A/V recording and communication doorbell.

In a sixth aspect, a method for protecting parcel assemblies from theft is provided, the method comprising: assembling a plurality of parcel assemblies by placing parcel contents within each one of a plurality of containers; and placing a self-addressed tracking device within a subset of the plurality of containers, wherein the subset of the plurality of containers includes some, but not all, of the plurality of containers; wherein each of the self-addressed tracking devices includes a housing; a wireless communication module located at least partially within the housing; a processing module located at least partially within the housing and communicatively coupled to the wireless communication module; a power source located at least partially within the housing and electrically coupled to the wireless communication module and the processing module; and a mailing address of an originator of the parcel assembly, the mailing address being on an exterior surface of the housing, and being configured to enable recipients of the parcel assemblies to return the self-addressed tracking devices to the originator of the parcel assemblies.

In an embodiment of the sixth aspect, the subset of the plurality of containers is generated by selecting containers at regular intervals as the plurality of containers pass a fixed point in an assembly process.

In another embodiment of the sixth aspect, the subset of the plurality of containers is generated by randomly selecting containers from among the plurality of containers.

In another embodiment of the sixth aspect, each of the self-addressed tracking devices further comprises an indicator on the exterior surface of the housing that postage for returning the self-addressed tracking device to an originator of the plurality of parcel assemblies will be paid by the addressee.

In another embodiment of the sixth aspect, the addressee is the originator of the plurality of parcel assemblies.

In another embodiment of the sixth aspect, the self-addressed tracking device further comprises postage on the exterior surface of the housing.

In another embodiment of the sixth aspect, the self-addressed tracking device further comprises an indicator on the exterior surface of the housing to return the self-addressed tracking device by depositing it in any mailbox.

In another embodiment of the sixth aspect, each of the containers comprises a box, a carton, a crate, an envelope, or a pouch.

In another embodiment of the sixth aspect, the self-addressed tracking device comprises a satellite navigation system tracking unit.

In another embodiment of the sixth aspect, the satellite navigation system tracking unit comprises a GPS (Global Positioning System) tracking unit or a GLONASS (Global Navigation Satellite System) tracking unit.

Another embodiment of the sixth aspect further comprises providing a notice on an outer surface of each of the containers in the subset of the plurality of containers, wherein the notice indicates that the parcel assembly contains an anti-theft device.

Another embodiment of the sixth aspect further comprises providing a notice on an outer surface of each of the plurality of containers, including the containers in the subset of the plurality of containers and the containers not in the subset of the plurality of containers, wherein the notice indicates that the parcel assembly contains an anti-theft device.

Another embodiment of the sixth aspect further comprises receiving a plurality of requests to include the self-addressed tracking devices within the parcel assemblies corresponding to the subset of the plurality of containers.

Another embodiment of the sixth aspect further comprises, in response to receiving the plurality of requests to include the self-addressed tracking devices within the parcel assemblies corresponding to the subset of the plurality of containers, receiving deposit payments for the self-addressed tracking devices, the deposit payments being refundable when the recipients of the parcel assemblies corresponding to the subset of the plurality of containers return the self-addressed tracking devices to the originator of the parcel assemblies corresponding to the subset of the plurality of containers.

In another embodiment of the sixth aspect, the subset of the plurality of containers is generated according to the plurality of requests to include the self-addressed tracking devices within the parcel assemblies corresponding to the subset of the plurality of containers.

### BRIEF DESCRIPTION OF THE DRAWINGS

The various embodiments of the present self-addressed parcel tracking devices and methods now will be discussed in detail with an emphasis on highlighting the advantageous features. These embodiments depict the novel and non-obvious self-addressed parcel tracking devices and methods shown in the accompanying drawings, which are for illustrative purposes only. These drawings include the following figures, in which like numerals indicate like parts:

FIG. 1 is a functional block diagram illustrating one embodiment of a system including an A/V recording and communication device according to various aspects of the present disclosure;

FIG. 2 is a flowchart illustrating one embodiment of a process for streaming and storing A/V content from an A/V recording and communication doorbell system according to various aspects of the present disclosure;

FIG. 3 is a functional block diagram illustrating an embodiment of an A/V recording and communication doorbell system according to the present disclosure;

FIG. 4 is a front perspective view of an embodiment of an A/V recording and communication doorbell according to the present disclosure;

FIG. 5 is a rear perspective view of the A/V recording and communication doorbell of FIG. 4;

FIG. 6 is a partially exploded front perspective view of the A/V recording and communication doorbell of FIG. 4 showing the cover removed;

FIGS. 7, 8, and 9 are front perspective views of various internal components of the A/V recording and communication doorbell of FIG. 4;

FIG. 10 is a right-side cross-sectional view of the A/V recording and communication doorbell of FIG. 4 taken through the line 10-10 in FIG. 4;

FIGS. 11-13 are rear perspective views of various internal components of the A/V recording and communication doorbell of FIG. 4;

FIG. 14 is a front view of an A/V recording and communication device according to various aspects of the present disclosure;

FIG. 15 is a rear view of the A/V recording and communication device of FIG. 14;

FIG. 16 is cross-sectional right side view of the A/V recording and communication device of FIG. 14;

FIG. 17 is an exploded view of the A/V recording and communication device of FIG. 14 and a mounting bracket;

FIG. 18 is a top view of a passive infrared sensor assembly according to various aspects of the present disclosure;

FIG. 19 is a front view of the passive infrared sensor assembly of FIG. 18;

FIG. 20 is a top view of the passive infrared sensor assembly of FIG. 18, illustrating the fields of view of the passive infrared sensors according to various aspects of the present disclosure;

FIG. 21 is a functional block diagram of the components of the A/V recording and communication device of FIG. 14;

FIG. 22 is a functional block diagram of one embodiment of a self-addressed parcel tracking device according to various aspects of the present disclosure;

FIG. 23 is a functional block diagram of one embodiment of a parcel assembly including a self-addressed parcel tracking device according to various aspects of the present disclosure;

FIG. 24 is a flowchart illustrating one embodiment of a process for including a self-addressed parcel tracking device in a parcel according to various aspects of the present disclosure;

FIG. 25 is a side perspective view of one embodiment of a parcel including a warning on an outer surface that the parcel contains a tracking device according to various aspects of the present disclosure;

FIG. 26 is a flowchart illustrating one embodiment of a process for protecting a parcel from theft using a tracking device and an A/V recording and communication device according to various aspects of the present disclosure;

FIG. 27 is a sequence diagram illustrating one embodiment of a process for protecting a parcel from theft using a tracking device and an A/V recording and communication device according to various aspects of the present disclosure;

FIG. 28 is a functional block diagram of a client device on which the present embodiments may be implemented according to various aspects of the present disclosure; and

FIG. 29 is a functional block diagram of a general-purpose computing system on which the present embodiments may be implemented according to various aspects of present disclosure.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

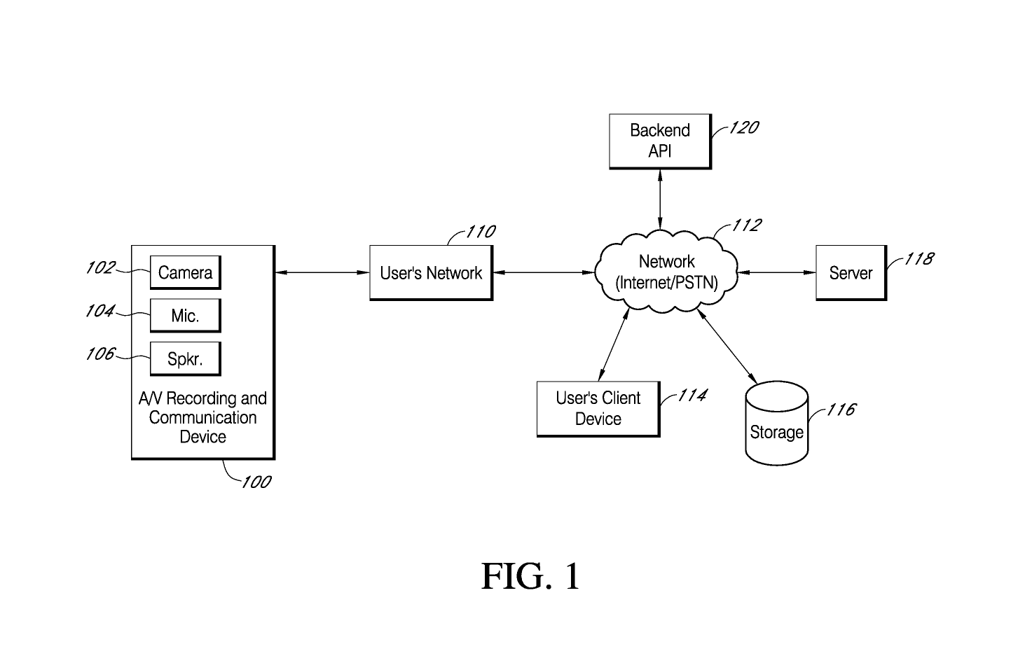

With reference to FIG. 1, the present embodiments may include an audio/video (A/V) recording and communication device 100. The A/V recording and communication device 100 may in some embodiments comprise a doorbell, and may be located near the entrance to a structure (not shown), such as a dwelling, a business, a storage facility, etc. The A/V recording and communication device 100 includes a camera 102, a microphone 104, and a speaker 106. The camera 102 may comprise, for example, a high definition (HD) video camera, such as one capable of capturing video images at an image display resolution of 720p, or 1080p, or better. While not shown, the A/V recording and communication device 100 may also include other hardware and/or components, such as a housing, one or more motion sensors (and/or other types of sensors), a button, etc. The A/V recording and communication device 100 may further include similar componentry and/or functionality as the wireless communication doorbells described in US Patent Application Publication Nos. 2015/0022620 (application Ser. No. 14/499,828) and 2015/0022618 (application Ser. No. 14/334,922), both of which are incorporated herein by reference in their entireties as if fully set forth.

With further reference to FIG. 1, the A/V recording and communication device 100 communicates with a user's network 110, which may be for example a wired and/or wireless network. If the user's network 110 is wireless, or includes a wireless component, the network 110 may be a Wi-Fi network compatible with the IEEE 802.11 standard and/or other wireless communication standard(s). The user's network 110 is connected to another network 112, which may comprise, for example, the Internet and/or a public switched telephone network (PSTN). As described below, the A/V recording and communication device 100 may communicate with a user's client device 114 via the user's network 110 and the network 112 (Internet/PSTN). The user's client device 114 may comprise, for example, a mobile telephone (may also be referred to as a cellular telephone), such as a smartphone, a personal digital assistant (PDA), or another communication device. The user's client device 114 comprises a display (not shown) and related components capable of displaying streaming and/or recorded video images. The user's client device 114 may also comprise a speaker and related components capable of broadcasting streaming and/or recorded audio, and may also comprise a microphone. The A/V recording and communication device 100 may also communicate with one or more remote storage device(s) 116 (may be referred to interchangeably as “cloud storage device(s)”), one or more servers 118, and/or a backend API (application programming interface) 120 via the user's network 110 and the network 112 (Internet/PSTN). While FIG. 1 illustrates the storage device 116, the server 118, and the backend API 120 as components separate from the network 112, it is to be understood that the storage device 116, the server 118, and/or the backend API 120 may be considered to be components of the network 112.

The network 112 may be any wireless network or any wired network, or a combination thereof, configured to operatively couple the above mentioned modules, devices, and systems as shown in FIG. 1. For example, the network 112 may include one or more of the following: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), LTE, VoLTE, LoRaWAN, LPWAN, RPMA, LTE Cat-“X” (e.g. LTE Cat 1, LTE Cat 0, LTE CatM1, LTE Cat NB1), CDMA (Code Division Multiple Access), TDMA (Time Division Multiple Access), FDMA (Frequency Division Multiple Access), and/or OFDMA (Orthogonal Frequency Division Multiple Access) cellular phone networks, GPS, CDPD (cellular digital packet data), RIM (Research in Motion, Limited) duplex paging network, Bluetooth radio, or an IEEE 802.11-based radio frequency network. The network can further include or interface with any one or more of the following: RS-232 serial connection, IEEE-1394 (Firewire) connection, Fibre Channel connection, IrDA (infrared) port, SCSI (Small Computer Systems Interface) connection, USB (Universal Serial Bus) connection, or other wired or wireless, digital or analog, interface or connection, mesh or Digi® networking.

According to one or more aspects of the present embodiments, when a person (may be referred to interchangeably as “visitor”) arrives at the A/V recording and communication device 100, the A/V recording and communication device 100 detects the visitor's presence and begins capturing video images within a field of view of the camera 102. The A/V recording and communication device 100 may also capture audio through the microphone 104. The A/V recording and communication device 100 may detect the visitor's presence by detecting motion using the camera 102 and/or a motion sensor, and/or by detecting that the visitor has depressed the front button on the A/V recording and communication device 100 (in embodiments in which the A/V recording and communication device 100 comprises a doorbell).

In response to the detection of the visitor, the A/V recording and communication device 100 sends an alert to the user's client device 114 (FIG. 1) via the user's network 110 and the network 112. The A/V recording and communication device 100 also sends streaming video, and may also send streaming audio, to the user's client device 114. If the user answers the alert, two-way audio communication may then occur between the visitor and the user through the A/V recording and communication device 100 and the user's client device 114. The user may view the visitor throughout the duration of the call, but the visitor cannot see the user (unless the A/V recording and communication device 100 includes a display, which it may in some embodiments).

The video images captured by the camera 102 of the A/V recording and communication device 100 (and the audio captured by the microphone 104) may be uploaded to the cloud and recorded on the remote storage device 116 (FIG. 1). In some embodiments, the video and/or audio may be recorded on the remote storage device 116 even if the user chooses to ignore the alert sent to his or her client device 114.

With further reference to FIG. 1, the system may further comprise a backend API 120 including one or more components. A backend API (application programming interface) may comprise, for example, a server (e.g. a real server, or a virtual machine, or a machine running in a cloud infrastructure as a service), or multiple servers networked together, exposing at least one API to client(s) accessing it. These servers may include components such as application servers (e.g. software servers), depending upon what other components are included, such as a caching layer, or database layers, or other components. A backend API may, for example, comprise many such applications, each of which communicate with one another using their public APIs. In some embodiments, the API backend may hold the bulk of the user data and offer the user management capabilities, leaving the clients to have very limited state.

The backend API 120 illustrated FIG. 1 may include one or more APIs. An API is a set of routines, protocols, and tools for building software and applications. An API expresses a software component in terms of its operations, inputs, outputs, and underlying types, defining functionalities that are independent of their respective implementations, which allows definitions and implementations to vary without compromising the interface. Advantageously, an API may provide a programmer with access to an application's functionality without the programmer needing to modify the application itself, or even understand how the application works. An API may be for a web-based system, an operating system, or a database system, and it provides facilities to develop applications for that system using a given programming language. In addition to accessing databases or computer hardware like hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications.

The backend API 120 illustrated in FIG. 1 may further include one or more services (also referred to as network services). A network service is an application that provides data storage, manipulation, presentation, communication, and/or other capability. Network services are often implemented using a client-server architecture based on application-layer network protocols. Each service may be provided by a server component running on one or more computers (such as a dedicated server computer offering multiple services) and accessed via a network by client components running on other devices. However, the client and server components can both be run on the same machine. Clients and servers may have a user interface, and sometimes other hardware associated with them.

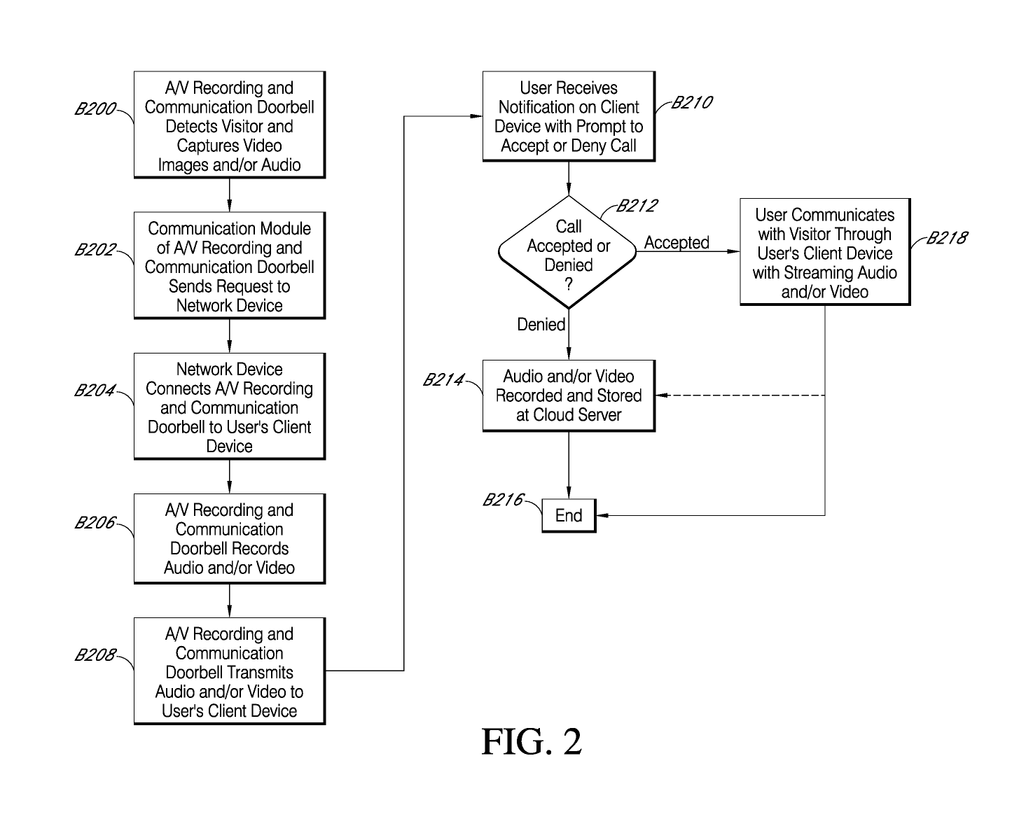

FIG. 2 is a flowchart illustrating a process for streaming and storing A/V content from an A/V recording and communication doorbell system according to various aspects of the present disclosure. At block B200, the A/V recording and communication device 100 detects the visitor's presence and begins capturing video images within a field of view of the camera 102. The A/V recording and communication device 100 may also capture audio through the microphone 104. As described above, the A/V recording and communication device 100 may detect the visitor's presence by detecting motion using the camera 102 and/or a motion sensor, and/or by detecting that the visitor has depressed the front button on the A/V recording and communication device 100 (in embodiments in which the A/V recording and communication device 100 comprises a doorbell).

At block B202, a communication module of the A/V recording and communication device 100 sends a connection request, via the user's network 110 and the network 112, to a device in the network 112. For example, the network device to which the request is sent may be a server such as the server 118. The server 118 may comprise a computer program and/or a machine that waits for requests from other machines or software (clients) and responds to them. A server typically processes data. One purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

In response to the request, at block B204 the network device may connect the A/V recording and communication device 100 to the user's client device 114 through the user's network 110 and the network 112. At block B206, the A/V recording and communication device 100 may record available audio and/or video data using the camera 102, the microphone 104, and/or any other sensor available. At block B208, the audio and/or video data is transmitted (streamed) from the A/V recording and communication device 100 to the user's client device 114 via the user's network 110 and the network 112. At block B210, the user may receive a notification on his or her client device 114 with a prompt to either accept or deny the call.

At block B212, the process determines whether the user has accepted or denied the call. If the user denies the notification, then the process advances to block B214, where the audio and/or video data is recorded and stored at a cloud server. The session then ends at block B216 and the connection between the A/V recording and communication device 100 and the user's client device 114 is terminated. If, however, the user accepts the notification, then at block B218 the user communicates with the visitor through the user's client device 114 while audio and/or video data captured by the camera 102, the microphone 104, and/or other sensors is streamed to the user's client device 114. At the end of the call, the user may terminate the connection between the user's client device 114 and the A/V recording and communication device 100 and the session ends at block B216. In some embodiments, the audio and/or video data may be recorded and stored at a cloud server (block B214) even if the user accepts the notification and communicates with the visitor through the user's client device 114.

Many of today's homes include a wired doorbell system that does not have A/V communication capabilities. Instead, standard wired doorbell systems include a button outside the home next to the front door. The button activates a signaling device (such as a bell or a buzzer) inside the building. Pressing the doorbell button momentarily closes the doorbell circuit, which may be, for example, a single-pole, single-throw (SPST) push button switch. One terminal of the button is wired to a terminal on a transformer. The transformer steps down the 120-volt or 240-volt household AC electrical power to a lower voltage, typically 16 to 24 volts. Another terminal on the transformer is wired to a terminal on the signaling device. Another terminal on the signaling device is wired to the other terminal on the button. A common signaling device includes two flat metal bar resonators, which are struck by plungers operated by two solenoids. The flat bars are tuned to different notes. When the doorbell button is pressed, the first solenoid's plunger strikes one of the bars, and when the button is released, a spring on the plunger pushes the plunger up, causing it to strike the other bar, creating a two-tone sound (“ding-dong”).

Many current A/V recording and communication doorbell systems (other than the present embodiments) are incompatible with existing wired doorbell systems of the type described in the preceding paragraph. One reason for this incompatibility is that the A/V recording and communication doorbell draws an amount of power from the household AC electrical power supply that is above the threshold necessary for causing the signaling device to sound. The A/V recording and communication doorbell thus causes frequent inadvertent sounding of the signaling device, which is not only bothersome to the home's occupant(s), but also undermines the usefulness of the doorbell. The present embodiments solve this problem by limiting the power consumption of the A/V recording and communication doorbell to an amount that is below the threshold necessary for causing the signaling device to sound. Embodiments of the present A/V recording and communication doorbell can thus be connected to the existing household AC power supply and the existing signaling device without causing inadvertent sounding of the signaling device.

Several advantages flow from the ability of the present embodiments to be connected to the existing household AC power supply. For example, the camera of the present A/V recording and communication doorbell can be powered on continuously. In a typical battery-powered A/V recording and communication doorbell, the camera is powered on only part of the time so that the battery does not drain too rapidly. The present embodiments, by contrast, do not rely on a battery as a primary (or sole) power supply, and are thus able to keep the camera powered on continuously. Because the camera is able to be powered on continuously, it can always be recording, and recorded footage can be continuously stored in a rolling buffer or sliding window. In some embodiments, about 10-15 seconds of recorded footage can be continuously stored in the rolling buffer or sliding window. Also because the camera is able to be powered on continuously, it can be used for motion detection, thus eliminating any need for a separate motion detection device, such as a passive infrared sensor (PIR). Eliminating the PIR simplifies the design of the A/V recording and communication doorbell and enables the doorbell to be made more compact. Also because the camera is able to be powered on continuously, it can be used as a light detector for use in controlling the current state of the IR cut filter and turning the IR LED on and off. Using the camera as a light detector eliminates any need for a separate light detector, thereby further simplifying the design of the A/V recording and communication doorbell and enabling the doorbell to be made even more compact.

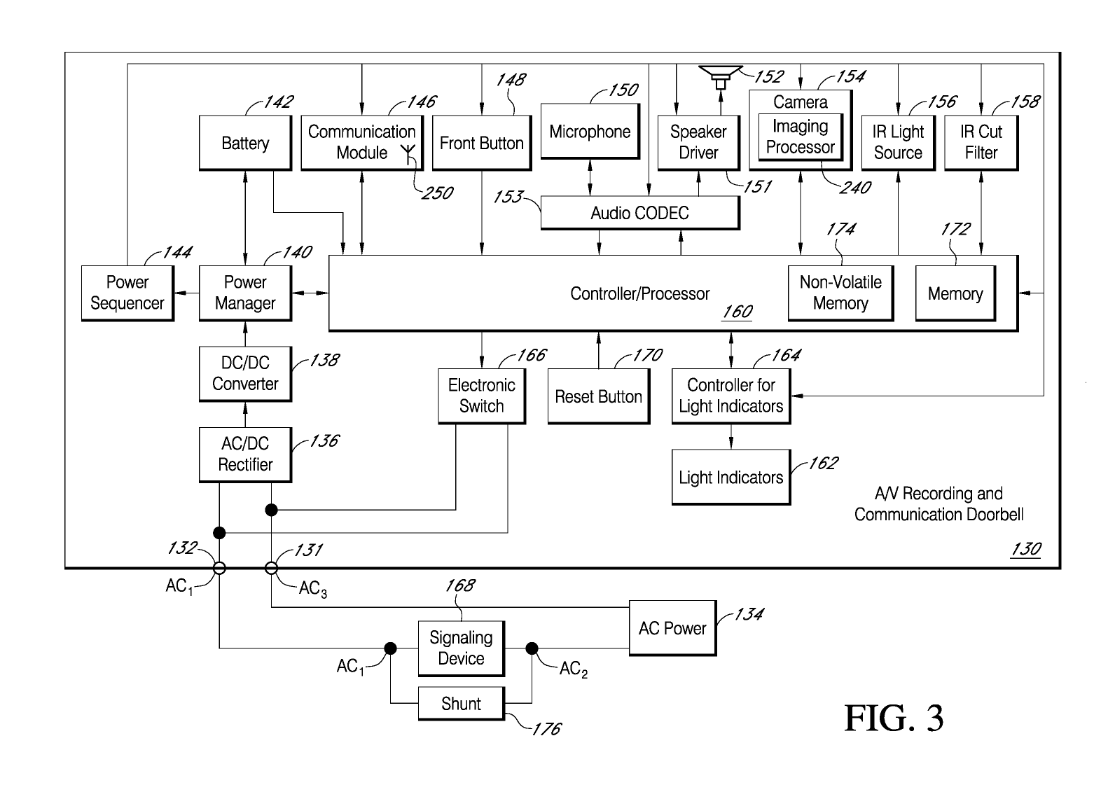

FIGS. 3-13 illustrate one embodiment of a low-power-consumption A/V recording and communication doorbell 130 according to various aspects of the present disclosure. FIG. 3 is a functional block diagram illustrating various components of the A/V recording and communication doorbell 130 and their relationships to one another. For example, the A/V recording and communication doorbell 130 includes a pair of terminals 131, 132 configured to be connected to a source of external AC (alternating-current) power, such as a household AC power supply 134 (may also be referred to as AC mains). The AC power 134 may have a voltage in the range of 16-24 VAC, for example. The incoming AC power 134 may be converted to DC (direct-current) by an AC/DC rectifier 136. An output of the AC/DC rectifier 136 may be connected to an input of a DC/DC converter 138, which may step down the voltage from the output of the AC/DC rectifier 136 from 16-24 VDC to a lower voltage of about 5 VDC, for example. In various embodiments, the output of the DC/DC converter 138 may be in a range of from about 2.5 V to about 7.5 V, for example.

With further reference to FIG. 3, the output of the DC/DC converter 138 is connected to a power manager 140, which may comprise an integrated circuit including a processor core, memory, and/or programmable input/output peripherals. In one non-limiting example, the power manager 140 may be an off-the-shelf component, such as the BQ24773 chip manufactured by Texas Instruments. As described in detail below, the power manager 140 controls, among other things, an amount of power drawn from the external power supply 134, as well as an amount of supplemental power drawn from a battery 142, to power the A/V recording and communication doorbell 130. The power manager 140 may, for example, limit the amount of power drawn from the external power supply 134 so that a threshold power draw is not exceeded. In one non-limiting example, the threshold power, as measured at the output of the DC/DC converter 138, may be equal to 1.4 A. The power manager 140 may also control an amount of power drawn from the external power supply 134 and directed to the battery 142 for recharging of the battery 142. An output of the power manager 140 is connected to a power sequencer 144, which controls a sequence of power delivery to other components of the A/V recording and communication doorbell 130, including a communication module 146, a front button 148, a microphone 150, a speaker driver 151, a speaker 152, an audio CODEC (Coder-DECoder) 153, a camera 154, an infrared (IR) light source 156, an IR cut filter 158, a processor 160 (may also be referred to as a controller 160), a plurality of light indicators 162, and a controller 164 for the light indicators 162. Each of these components is described in detail below. The power sequencer 144 may comprise an integrated circuit including a processor core, memory, and/or programmable input/output peripherals. In one non-limiting example, the power sequencer 144 may be an off-the-shelf component, such as the RT5024 chip manufactured by Richtek.

With further reference to FIG. 3, the A/V recording and communication doorbell 130 further comprises an electronic switch 166 that closes when the front button 148 is depressed. When the electronic switch 166 closes, power from the AC power source 134 is diverted through a signaling device 168 that is external to the A/V recording and communication doorbell 130 to cause the signaling device 168 to emit a sound, as further described below. In one non-limiting example, the electronic switch 166 may be a triac device. The A/V recording and communication doorbell 130 further comprises a reset button 170 configured to initiate a hard reset of the processor 160, as further described below.

With further reference to FIG. 3, the processor 160 may perform data processing and various other functions, as described below. The processor 160 may comprise an integrated circuit including a processor core, memory 172, non-volatile memory 174, and/or programmable input/output peripherals (not shown). The memory 172 may comprise, for example, DDR3 (double data rate type three synchronous dynamic random-access memory). The non-volatile memory 174 may comprise, for example, NAND flash memory. In the embodiment illustrated in FIG. 3, the memory 172 and the non-volatile memory 174 are illustrated within the box representing the processor 160. It is to be understood that the embodiment illustrated in FIG. 3 is merely an example, and in some embodiments the memory 172 and/or the non-volatile memory 174 are not necessarily physically incorporated with the processor 160. The memory 172 and/or the non-volatile memory 174, regardless of their physical location, may be shared by one or more other components (in addition to the processor 160) of the present A/V recording and communication doorbell 130.

The transfer of digital audio between the user and a visitor may be compressed and decompressed using the audio CODEC 153, which is operatively coupled to the processor 160. When the visitor speaks, audio from the visitor is compressed by the audio CODEC 153, digital audio data is sent through the communication module 146 to the network 112 via the user's network 110, routed by the server 118 and delivered to the user's client device 114. When the user speaks, after being transferred through the network 112, the user's network 110, and the communication module 146, the digital audio data is decompressed by the audio CODEC 153 and emitted to the visitor through the speaker 152, which is driven by the speaker driver 151.

With further reference to FIG. 3, some of the present embodiments may include a shunt 176 connected in parallel with the signaling device 168. The shunt 176 facilitates the ability of the A/V recording and communication doorbell 130 to draw power from the AC power source 134 without inadvertently triggering the signaling device 168. The shunt 176, during normal standby operation, presents a relatively low electrical impedance, such as a few ohms, across the terminals of the signaling device 168. Most of the current drawn by the A/V recording and communication doorbell 130, therefore, flows through the shunt 176, and not through the signaling device 168. The shunt 176, however, contains electronic circuitry (described below) that switches the shunt 176 between a state of low impedance, such as a few ohms, for example, and a state of high impedance, such as >1K ohms, for example. When the front button 148 of the A/V recording and communication doorbell 130 is pressed, the electronic switch 166 closes, causing the voltage from the AC power source 134 to be impressed mostly across the shunt 176 and the signaling device 168 in parallel, while a small amount of voltage, such as about 1V, is impressed across the electronic switch 166. The circuitry in the shunt 176 senses this voltage, and switches the shunt 176 to the high impedance state, so that power from the AC power source 134 is diverted through the signaling device 168. The diverted AC power 134 is above the threshold necessary to cause the signaling device 168 to emit a sound. Pressing the front button 148 of the doorbell 130 therefore causes the signaling device 168 to “ring,” alerting any person(s) within the structure to which the doorbell 130 is mounted that there is a visitor at the front door (or at another location corresponding to the location of the doorbell 130). In one non-limiting example, the electronic switch 166 may be a triac device.

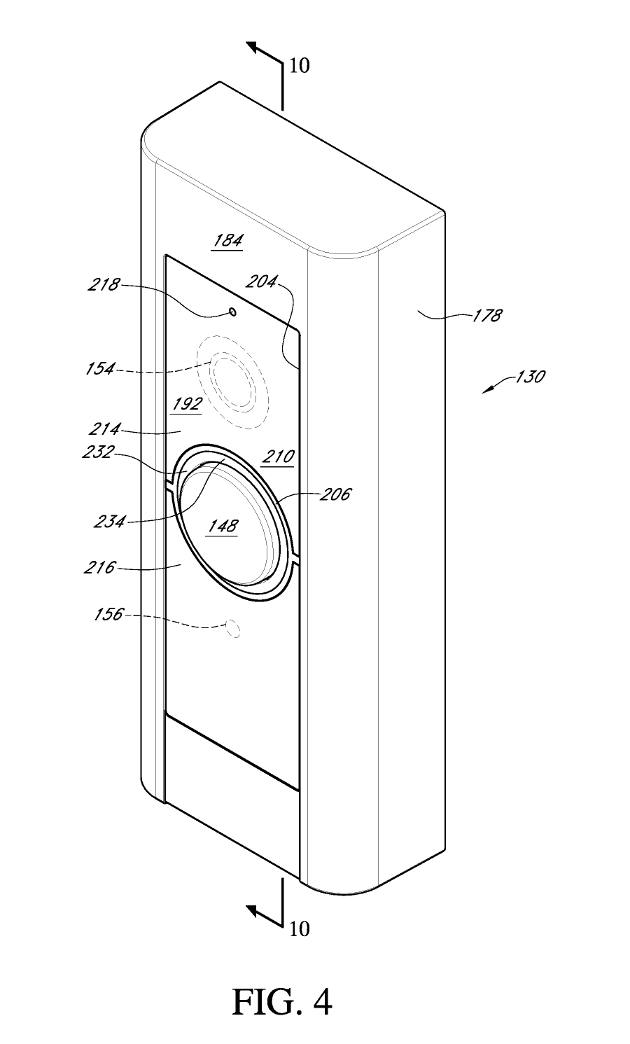

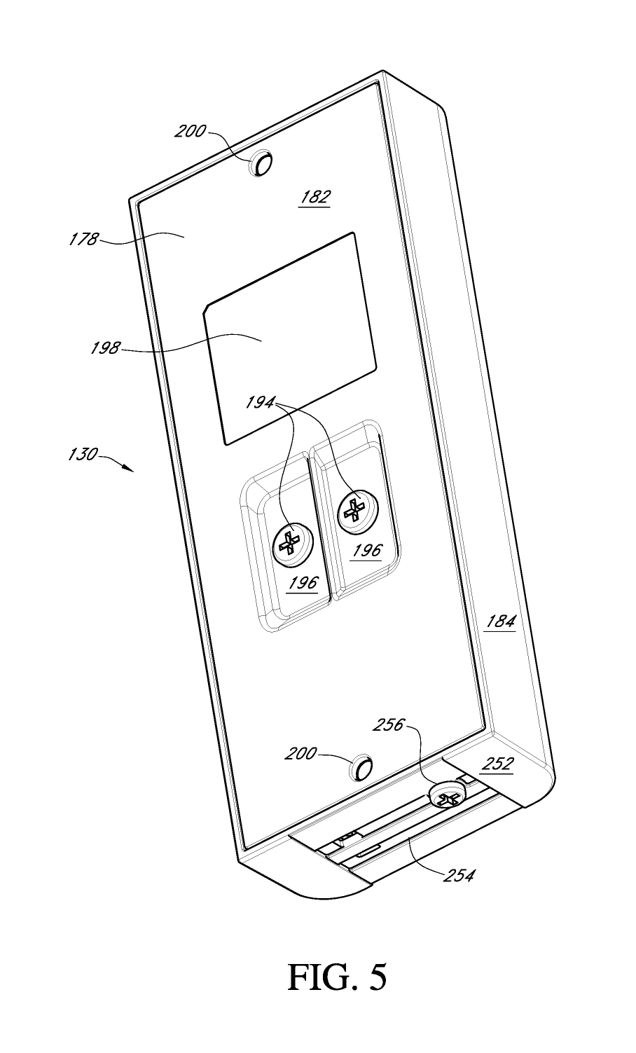

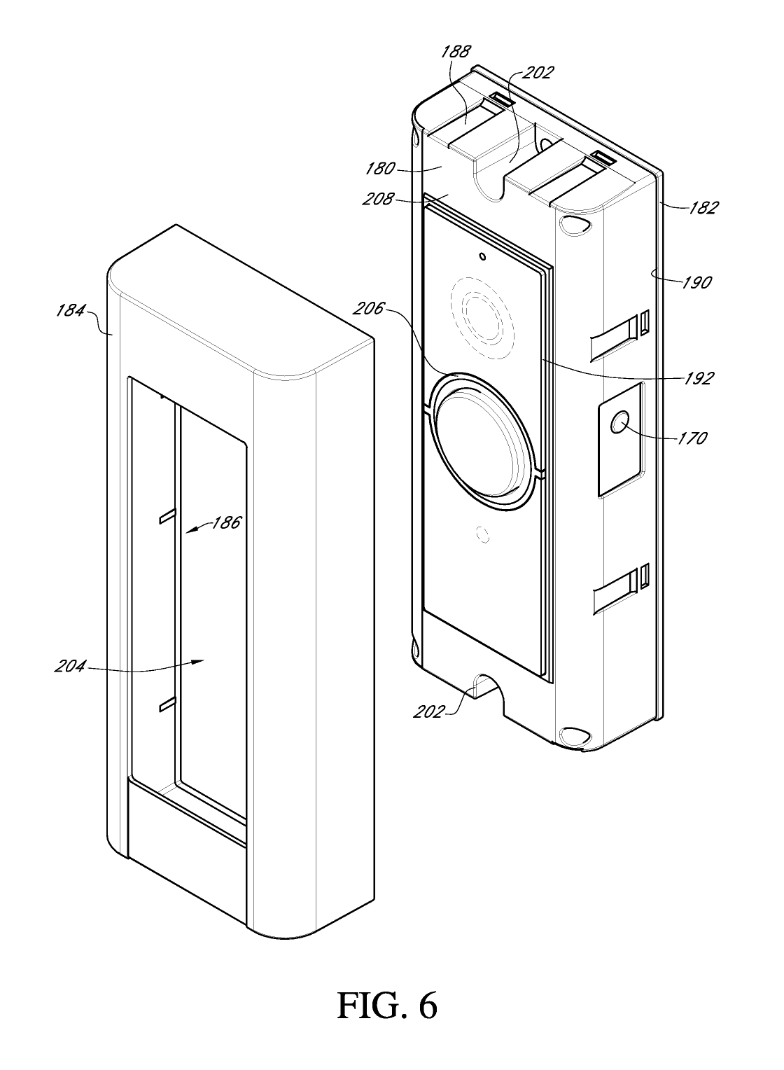

With reference to FIGS. 4-6, the A/V recording and communication doorbell 130 further comprises a housing 178 having an enclosure 180 (FIG. 6), a back plate 182 secured to the rear of the enclosure 180, and a shell 184 overlying the enclosure 180. With reference to FIG. 6, the shell 184 includes a recess 186 that is sized and shaped to receive the enclosure 180 in a close fitting engagement, such that outer surfaces of the enclosure 180 abut conforming inner surfaces of the shell 184. Exterior dimensions of the enclosure 180 may be closely matched with interior dimensions of the shell 184 such that friction maintains the shell 184 about the enclosure 180. Alternatively, or in addition, the enclosure 180 and/or the shell 184 may include mating features 188, such as one or more tabs, grooves, slots, posts, etc. to assist in maintaining the shell 184 about the enclosure 180. The back plate 182 is sized and shaped such that the edges of the back plate 182 extend outward from the edges of the enclosure 180, thereby creating a lip 190 against which the shell 184 abuts when the shell 184 is mated with the enclosure 180, as shown in FIGS. 4 and 5. In some embodiments, multiple shells 184 in different colors may be provided so that the end user may customize the appearance of his or her A/V recording and communication doorbell 130. For example, the A/V recording and communication doorbell 130 may be packaged and sold with multiple shells 184 in different colors in the same package.

With reference to FIG. 4, a front surface of the A/V recording and communication doorbell 130 includes the button 148 (may also be referred to as front button 148, FIG. 3), which is operatively connected to the processor 160. In a process similar to that described above with reference to FIG. 2, when a visitor presses the front button 148, an alert may be sent to the user's client device to notify the user that someone is at his or her front door (or at another location corresponding to the location of the A/V recording and communication doorbell 130). With further reference to FIG. 4, the A/V recording and communication doorbell 130 further includes the camera 154, which is operatively connected to the processor 160, and which is located behind a shield 192. As described in detail below, the camera 154 is configured to capture video images from within its field of view. Those video images can be streamed to the user's client device and/or uploaded to a remote network device for later viewing according to a process similar to that described above with reference to FIG. 2.

With reference to FIG. 5, a pair of terminal screws 194 extends through the back plate 182. The terminal screws 194 are connected at their inner ends to the terminals 131, 132 (FIG. 3) within the A/V recording and communication doorbell 130. The terminal screws 194 are configured to receive electrical wires to connect to the A/V recording and communication doorbell 130, through the terminals 131, 132, to the household AC power supply 134 of the structure on which the A/V recording and communication doorbell 130 is mounted. In the illustrated embodiment, the terminal screws 194 are located within a recessed portion 196 of the rear surface 198 of the back plate 182 so that the terminal screws 194 do not protrude from the outer envelope of the A/V recording and communication doorbell 130. The A/V recording and communication doorbell 130 can thus be mounted to a mounting surface with the rear surface 198 of the back plate 182 abutting the mounting surface. The back plate 182 includes apertures 200 adjacent its upper and lower edges to accommodate mounting hardware, such as screws (not shown), for securing the back plate 182 (and thus the A/V recording and communication doorbell 130) to the mounting surface. With reference to FIG. 6, the enclosure 180 includes corresponding apertures 202 adjacent its upper and lower edges that align with the apertures 200 in the back plate 182 to accommodate the mounting hardware. In certain embodiments, the A/V recording and communication doorbell 130 may include a mounting plate or bracket (not shown) to facilitate securing the A/V recording and communication doorbell 130 to the mounting surface.

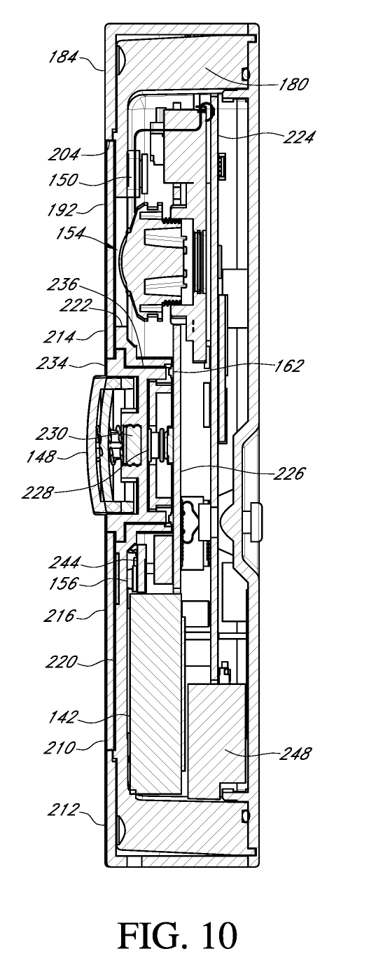

With further reference to FIG. 6, the shell 184 includes a central opening 204 in a front surface. The central opening 204 is sized and shaped to accommodate the shield 192. In the illustrated embodiment, the shield 192 is substantially rectangular, and includes a central opening 206 through which the front button 148 protrudes. The shield 192 defines a plane parallel to and in front of a front surface 208 of the enclosure 180. When the shell 184 is mated with the enclosure 180, as shown in FIGS. 4 and 10, the shield 192 resides within the central opening 204 of the shell 184 such that a front surface 210 of the shield 192 is substantially flush with a front surface 212 of the shell 184 and there is little or no gap (FIG. 4) between the outer edges of the shield 192 and the inner edges of the central opening 204 in the shell 184.

With further reference to FIG. 6, the shield 192 includes an upper portion 214 (located above and to the sides of the front button 148) and a lower portion 216 (located below and to the sides of the front button 148). The upper and lower portions 214, 216 of the shield 192 may be separate pieces, and may comprise different materials. The upper portion 214 of the shield 192 may be transparent or translucent so that it does not interfere with the field of view of the camera 154. For example, in certain embodiments the upper portion 214 of the shield 192 may comprise glass or plastic. As described in detail below, the microphone 150, which is operatively connected to the processor 160, is located behind the upper portion 214 of the shield 192. The upper portion 214, therefore, may include an opening 218 that facilitates the passage of sound through the shield 192 so that the microphone 150 is better able to pick up sounds from the area around the A/V recording and communication doorbell 130.

The lower portion 216 of the shield 192 may comprise a material that is substantially transparent to infrared (IR) light, but partially or mostly opaque with respect to light in the visible spectrum. For example, in certain embodiments the lower portion 216 of the shield 192 may comprise a plastic, such as polycarbonate. The lower portion 216 of the shield 192, therefore, does not interfere with transmission of IR light from the IR light source 156, which is located behind the lower portion 216. As described in detail below, the IR light source 156 and the IR cut filter 158, which are both operatively connected to the processor 160, facilitate “night vision” functionality of the camera 154.

The upper portion 214 and/or the lower portion 216 of the shield 192 may abut an underlying cover 220 (FIG. 10), which may be integral with the enclosure 180 or may be a separate piece. The cover 220, which may be opaque, may include a first opening 222 corresponding to the location of the camera 154, a second opening (not shown) corresponding to the location of the microphone 150 and the opening 218 in the upper portion 214 of the shield 192, and a third opening (not shown) corresponding to the location of the IR light source 156.

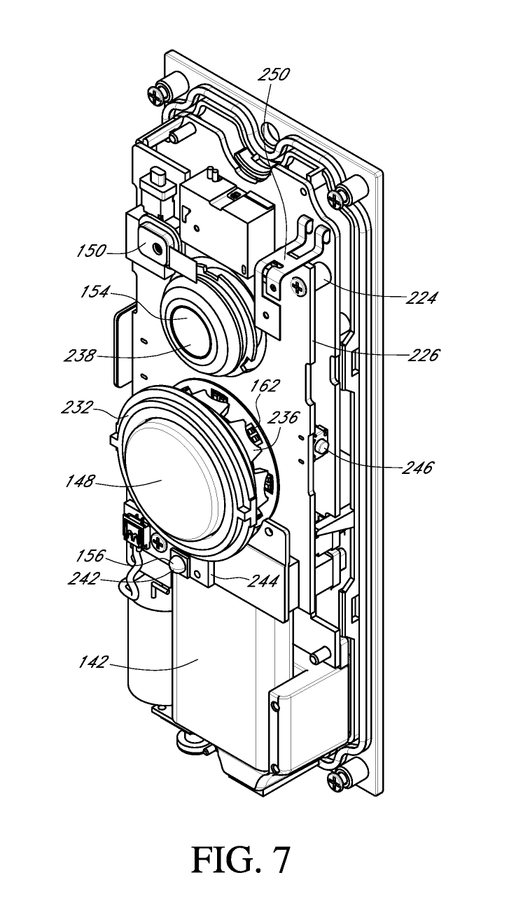

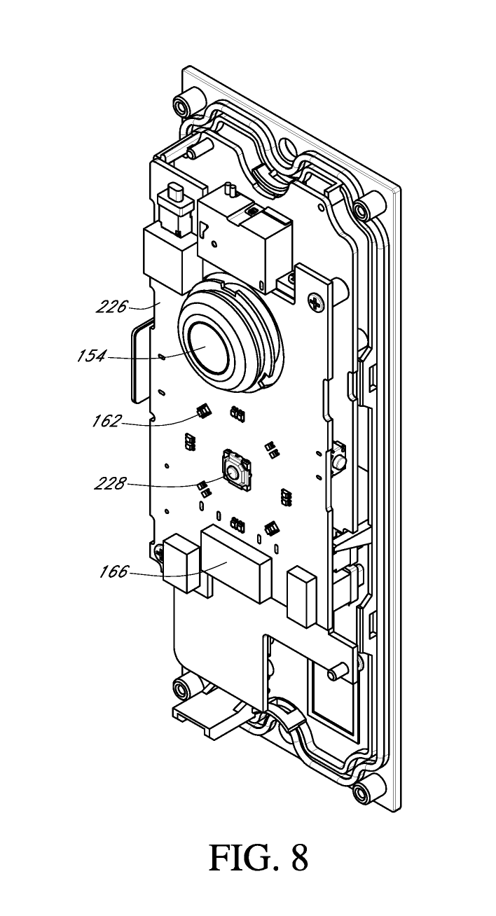

FIGS. 7-10 illustrate various internal components of the A/V recording and communication doorbell 130. FIGS. 7-9 are front perspective views of the doorbell 130 with the shell 184 and the enclosure 180 removed, while FIG. 10 is a right-side cross-sectional view of the doorbell 130 taken through the line 10-10 in FIG. 4. With reference to FIGS. 7 and 8, the A/V recording and communication doorbell 130 further comprises a main printed circuit board (PCB) 224 and a front PCB 226. With reference to FIG. 8, the front PCB 226 comprises a button actuator 228. With reference to FIGS. 7, 8, and 10, the front button 148 is located in front of the button actuator 228. The front button 148 includes a stem 230 (FIG. 10) that extends into the housing 178 to contact the button actuator 228. When the front button 148 is pressed, the stem 230 depresses the button actuator 228, thereby closing the electronic switch 166 (FIG. 8), as described below.

With reference to FIG. 8, the front PCB 226 further comprises the light indicators 162, which may illuminate when the front button 148 of the doorbell 130 is pressed. In the illustrated embodiment, the light indicators 162 comprise light-emitting diodes (LEDs 162) that are surface mounted to the front surface of the front PCB 226 and are arranged in a circle around the button actuator 228. The present embodiments are not limited to the light indicators 162 being LEDs, and in alternative embodiments the light indicators 162 may comprise any other type of light-emitting device. The present embodiments are also not limited by the number of light indicators 162 shown in FIG. 8, nor by the pattern in which they are arranged.

With reference to FIG. 7, the doorbell 130 further comprises a light pipe 232. The light pipe 232 is a transparent or translucent ring that encircles the front button 148. With reference to FIG. 4, the light pipe 232 resides in an annular space between the front button 148 and the central opening 206 in the shield 192, with a front surface 234 of the light pipe 232 being substantially flush with the front surface 210 of the shield 192. With reference to FIGS. 7 and 10, a rear portion of light pipe 232 includes a plurality of posts 236 whose positions correspond to the positions of the LEDs 162. When the LEDs 162 are illuminated, light is transmitted through the posts 236 and the body of the light pipe 232 so that the light is visible at the front surface 234 of the light pipe 232. The LEDs 162 and the light pipe 232 thus provide a ring of illumination around the front button 148. The light pipe 232 may comprise a plastic, for example, or any other suitable material capable of transmitting light.

The LEDs 162 and the light pipe 232 may function as visual indicators for a visitor and/or a user. For example, the LEDs 162 may illuminate upon activation or stay illuminated continuously. In one aspect, the LEDs 162 may change color to indicate that the front button 148 has been pressed. The LEDs 162 may also indicate that the battery 142 needs recharging, or that the battery 142 is currently being charged, or that charging of the battery 142 has been completed. The LEDs 162 may indicate that a connection to the user's wireless (and/or wired) network is good, limited, poor, or not connected. The LEDs 162 may be used to guide the user through setup or installation steps using visual cues, potentially coupled with audio cues emitted from the speaker 152.

With further reference to FIG. 7, the A/V recording and communication doorbell 130 further comprises a rechargeable battery 142. As described in further detail below, the A/V recording and communication doorbell 130 is connected to an external power source 134 (FIG. 3), such as AC mains. The A/V recording and communication doorbell 130 is primarily powered by the external power source 134, but may also draw power from the rechargeable battery 142 so as not to exceed a threshold amount of power from the external power source 134, to thereby avoid inadvertently sounding the signaling device 168. With reference to FIG. 3, the battery 142 is operatively connected to the power manager 140. As described below, the power manager 140 controls an amount of power drawn from the battery 142 to supplement the power drawn from the external AC power source 134 to power the A/V recording and communication doorbell 130 when supplemental power is needed. The power manager 140 also controls recharging of the battery 142 using power drawn from the external power source 134. The battery 142 may comprise, for example, a lithium-ion battery, or any other type of rechargeable battery.

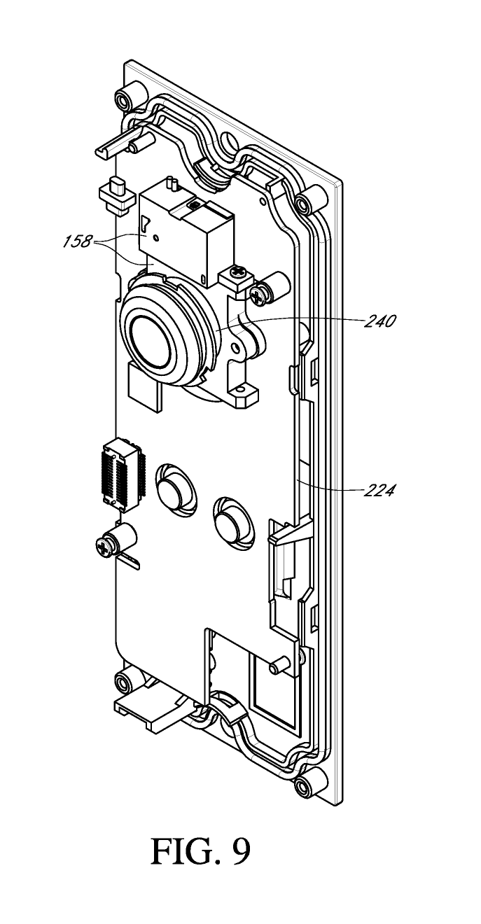

With further reference to FIG. 7, the A/V recording and communication doorbell 130 further comprises the camera 154. The camera 154 is coupled to a front surface of the front PCB 226, and includes a lens 238 and an imaging processor 240 (FIG. 9). The camera lens 238 may be a lens capable of focusing light into the camera 154 so that clear images may be captured. The camera 154 may comprise, for example, a high definition (HD) video camera, such as one capable of capturing video images at an image display resolution of 720p or better. In certain of the present embodiments, the camera 154 may be used to detect motion within its field of view, as described below.

With further reference to FIG. 7, the A/V recording and communication doorbell 130 further comprises an infrared (IR) light source 242. In the illustrated embodiment, the IR light source 242 comprises an IR light-emitting diode (LED) 242 coupled to an IR LED printed circuit board (PCB) 244. In alternative embodiments, the IR LED 242 may not comprise a separate PCB 244, and may, for example, be coupled to the front PCB 226.

With reference to FIGS. 7 and 10, the IR LED PCB 244 is located below the front button 148 (FIG. 7) and behind the lower portion 216 of the shield 192 (FIG. 10). As described above, the lower portion 216 of the shield 192 is transparent to IR light, but may be opaque with respect to light in the visible spectrum.

The IR LED 242 may be triggered to activate when a low level of ambient light is detected. When activated, IR light emitted from the IR LED 242 illuminates the camera 154′s field of view. The camera 154, which may be configured to detect IR light, may then capture the IR light emitted by the IR LED 242 as it reflects off objects within the camera 154′s field of view, so that the A/V recording and communication doorbell 130 can clearly capture images at night (may be referred to as “night vision”).

With reference to FIG. 9, the A/V recording and communication doorbell 130 further comprises an IR cut filter 158. The IR cut filter 158 is a mechanical shutter that can be selectively positioned between the lens 238 and the image sensor of the camera 154. During daylight hours, or whenever there is a sufficient amount of ambient light, the IR cut filter 158 is positioned between the lens 238 and the image sensor to filter out IR light so that it does not distort the colors of images as the human eye sees them. During nighttime hours, or whenever there is little to no ambient light, the IR cut filter 158 is withdrawn from the space between the lens 238 and the image sensor, so that the camera 154 is sensitive to IR light (“night vision”). In some embodiments, the camera 154 acts as a light detector for use in controlling the current state of the IR cut filter 158 and turning the IR LED 242 on and off. Using the camera 154 as a light detector is facilitated in some embodiments by the fact that the A/V recording and communication doorbell 130 is powered by a connection to AC mains, and the camera 154, therefore, is always powered on. In other embodiments, however, the A/V recording and communication doorbell 130 may include a light sensor separate from the camera 154 for use in controlling the IR cut filter 158 and the IR LED 242.

With reference back to FIG. 6, the A/V recording and communication doorbell 130 further comprises a reset button 170. The reset button 170 contacts a reset button actuator 246 (FIG. 8) coupled to the front PCB 226. When the reset button 170 is pressed, it may contact the reset button actuator 246, which may trigger the erasing of any data stored at the non-volatile memory 174 and/or at the memory 172 (FIG. 3), and/or may trigger a reboot of the processor 160.

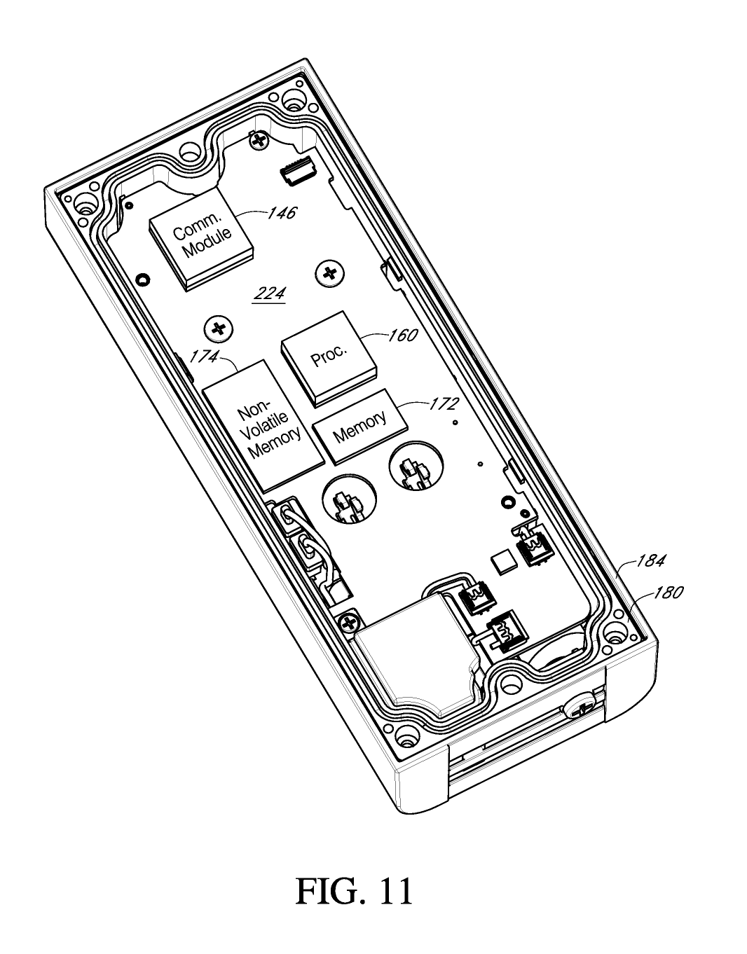

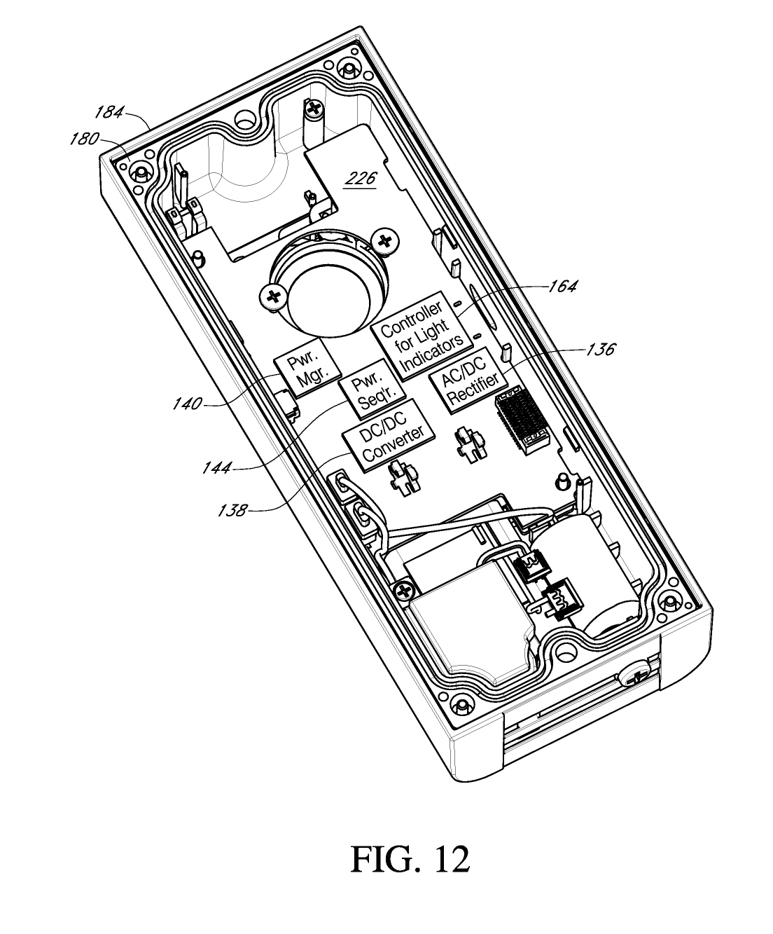

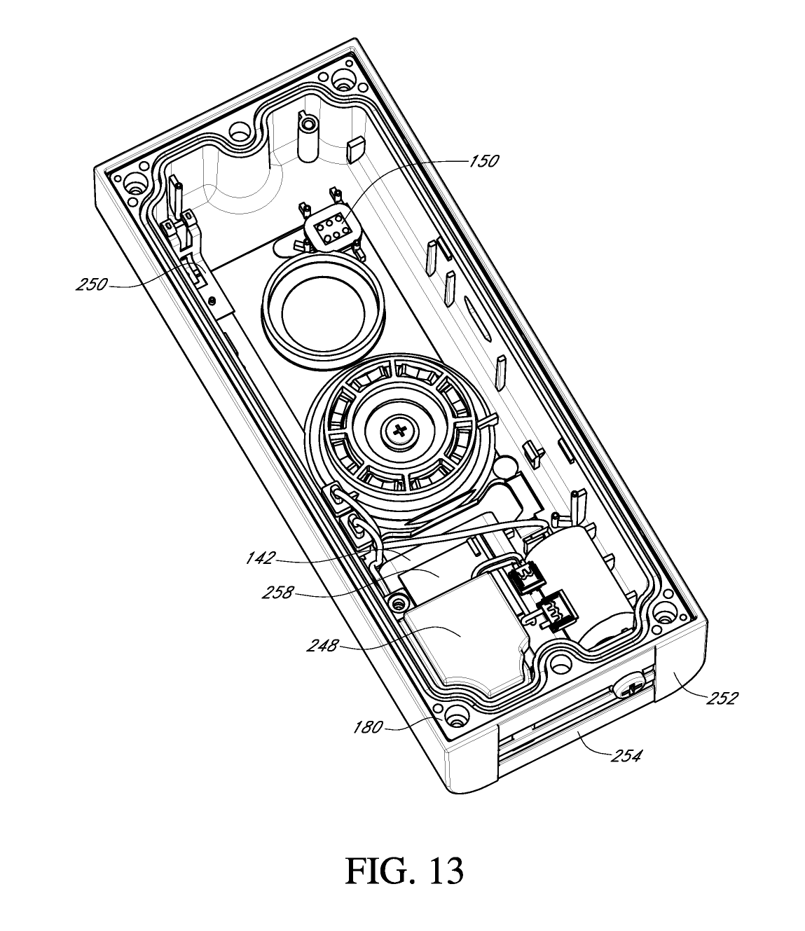

FIGS. 11-13 further illustrate internal components of the A/V recording and communication doorbell 130. FIGS. 11-13 are rear perspective views of the doorbell 130 with the back plate 182 and additional components removed. For example, in FIG. 11 the back plate 182 is removed, while in FIG. 12 the back plate 182 and the main PCB 224 are removed, and in FIG. 13 the back plate 182, the main PCB 224, and the front PCB 226 are removed. With reference to FIG. 11, several components are coupled to the rear surface of the main PCB 224, including the communication module 146, the processor 160, memory 172, and non-volatile memory 174. The functions of each of these components are described below. With reference to FIG. 12, several components are coupled to the rear surface of the front PCB 226, including the power manager 140, the power sequencer 144, the AC/DC rectifier 136, the DC/DC converter 138, and the controller 164 for the light indicators 162. The functions of each of these components are also described below. With reference to FIG. 13, several components are visible within the enclosure 180, including the microphone 150, a speaker chamber 248 (in which the speaker 152 is located), and an antenna 250 for the communication module 146. The functions of each of these components are also described below.

With reference to FIG. 7, the antenna 250 is coupled to the front surface of the main PCB 224 and operatively connected to the communication module 146, which is coupled to the rear surface of the main PCB 224 (FIG. 11). The microphone 150, which may also be coupled to the front surface of the main PCB 224, is located near the opening 218 (FIG. 4) in the upper portion 214 of the shield 192 so that sounds emanating from the area around the A/V recording and communication doorbell 130 can pass through the opening 218 and be detected by the microphone 150. With reference to FIG. 13, the speaker chamber 248 is located near the bottom of the enclosure 180. The speaker chamber 248 comprises a hollow enclosure in which the speaker 152 is located. The hollow speaker chamber 248 amplifies the sounds made by the speaker 152 so that they can be better heard by a visitor in the area near the A/V recording and communication doorbell 130. With reference to FIGS. 5 and 13, the lower surface 252 of the shell 184 and the lower surface (not shown) of the enclosure 180 may include an acoustical opening 254 through which the sounds made by the speaker 152 can pass so that they can be better heard by a visitor in the area near the A/V recording and communication doorbell 130. In the illustrated embodiment, the acoustical opening 254 is shaped generally as a rectangle having a length extending substantially across the lower surface 252 of the shell 184 (and also the enclosure 180). The illustrated shape is, however, just one example. With reference to FIG. 5, the lower surface 252 of the shell 184 may further include an opening 256 for receiving a security screw (not shown). The security screw may extend through the opening 256 and into a similarly located opening in the enclosure 180 to secure the shell 184 to the enclosure 180. If the doorbell 130 is mounted to a mounting bracket (not shown), the security screw may also maintain the doorbell 130 on the mounting bracket.

With reference to FIG. 13, the A/V recording and communication doorbell 130 may further include a battery heater 258. The present A/V recording and communication doorbell 130 is configured for outdoor use, including in cold climates. Cold temperatures, however, can cause negative performance issues for rechargeable batteries, such as reduced energy capacity, increased internal resistance, reduced ability to charge without damage, and reduced ability to supply load current. The battery heater 258 helps to keep the rechargeable battery 142 warm in order to reduce or eliminate the foregoing negative performance issues. In the illustrated embodiment, the battery heater 258 comprises a substantially flat, thin sheet abutting a side surface of the rechargeable battery 142. The battery heater 258 may comprise, for example, an electrically resistive heating element that produces heat when electrical current is passed through it. The battery heater 258 may thus be operatively coupled to the power manager 140 and/or the power sequencer 144 (FIG. 12). In some embodiments, the rechargeable battery 142 may include a thermally sensitive resistor (“thermistor,” not shown) operatively connected to the processor 160 so that the battery 142's temperature can be monitored and the amount of power supplied to the battery heater 258 can be adaptively controlled to keep the rechargeable battery 142 within a desired temperature range.

As described above, the present embodiments advantageously limit the power consumption of the A/V recording and communication doorbell to an amount that is below the threshold necessary for causing the signaling device to sound (except when the front button of the doorbell is pressed). The present A/V recording and communication doorbell can thus be connected to the existing household AC power supply and the existing signaling device without causing inadvertent sounding of the signaling device.

Several advantages flow from the ability of the present embodiments to be connected to the existing household AC power supply. For example, the camera of the present A/V recording and communication doorbell can be powered on continuously. In a typical battery-powered A/V recording and communication doorbell, the camera is powered on only part of the time so that the battery does not drain too rapidly. The present embodiments, by contrast, do not rely on a battery as a primary (or sole) power supply, and are thus able to keep the camera powered on continuously. Because the camera is able to be powered on continuously, it can always be recording, and recorded footage can be continuously stored in a rolling buffer or sliding window. In some embodiments, about 10-15 seconds of recorded footage can be continuously stored in the rolling buffer or sliding window. Also because the camera is able to be powered on continuously, it can be used for motion detection, thus eliminating any need for a separate motion detection device, such as a passive infrared sensor (PIR). Eliminating the PIR simplifies the design of the A/V recording and communication doorbell and enables the doorbell to be made more compact, although in some alternative embodiments the doorbell may include one or more PIRs and/or other motion detectors, heat source detectors, etc. Also because the camera is able to be powered on continuously, it can be used as a light detector for use in controlling the current state of the IR cut filter and turning the IR LED on and off. Using the camera as a light detector eliminates any need for a separate light detector, thereby further simplifying the design of the A/V recording and communication doorbell and enabling the doorbell to be made even more compact, although in some alternative embodiments the doorbell may include a separate light detector.

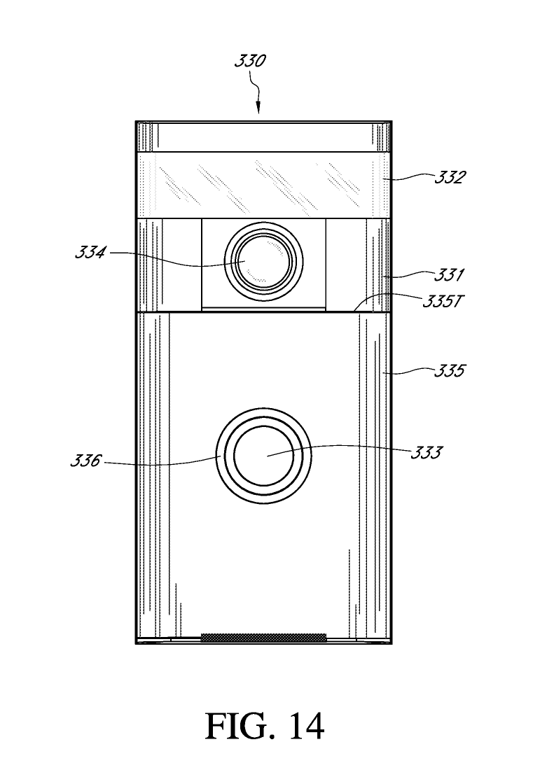

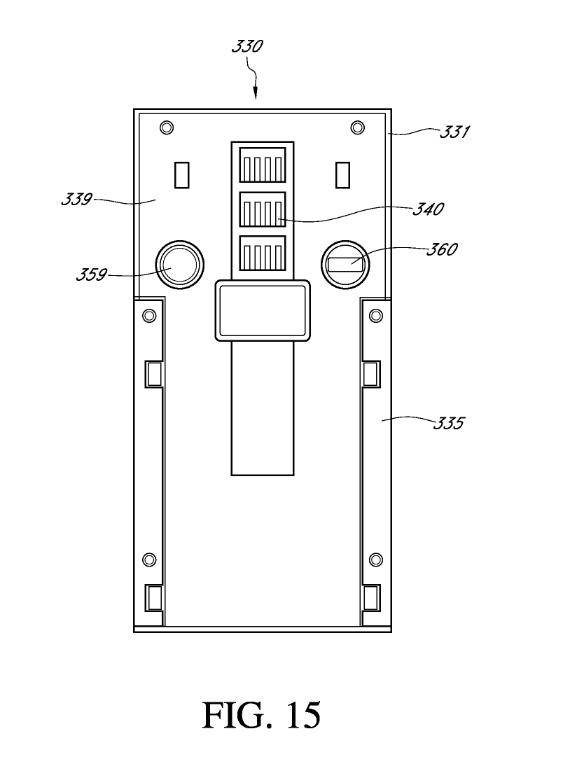

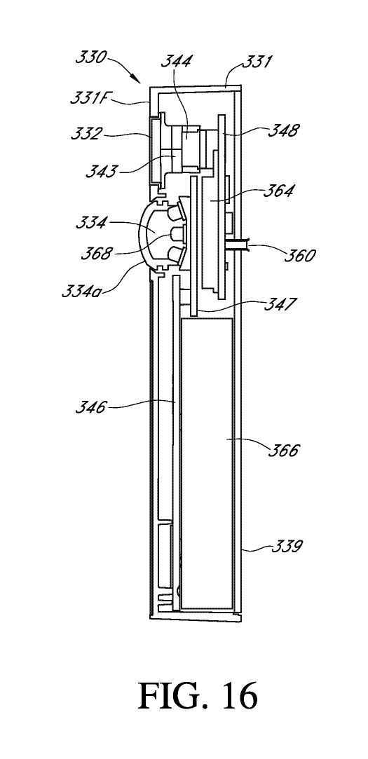

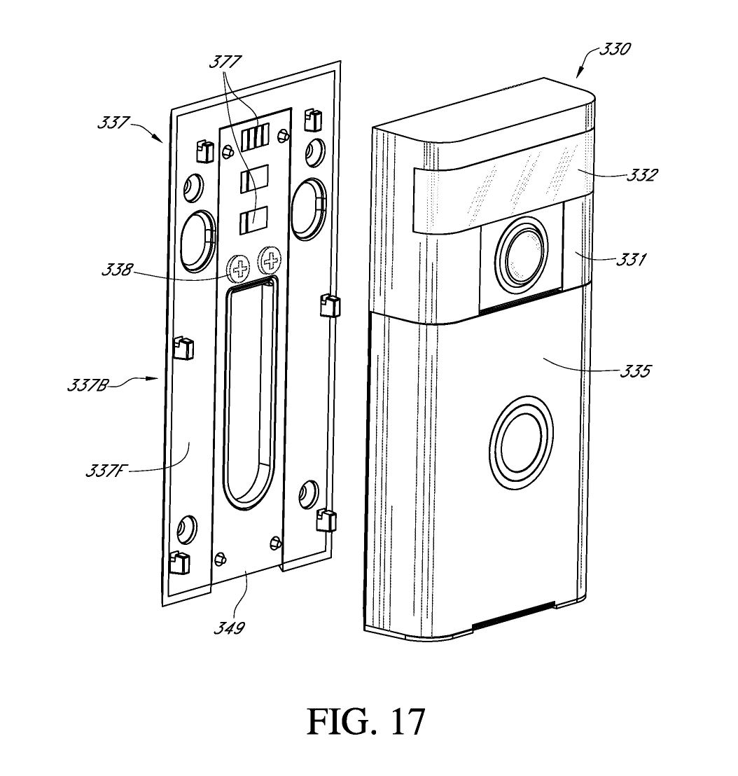

FIGS. 14-18 illustrate another embodiment of a wireless audio/video (A/V) communication doorbell 330 according to an aspect of present embodiments. FIG. 14 is a front view, FIG. 15 is a rear view, FIG. 16 is a right-side cross-sectional view, and FIG. 17 is an exploded view of the doorbell 330 and a mounting bracket 337. As described below, the doorbell 330 is configured to be connected to an external power source, such as household wiring, but is also configured to be powered by an on-board rechargeable battery instead of, or in addition to, the external power source.

The doorbell 330 includes a faceplate 335 mounted to a back plate 339 (FIG. 15). With reference to FIG. 16, the faceplate 335 has a substantially flat profile. The faceplate 335 may comprise any suitable material, including, without limitation, metals, such as brushed aluminum or stainless steel, metal alloys, or plastics. The faceplate 335 protects the internal contents of the doorbell 330 and serves as an exterior front surface of the doorbell 330.

With reference to FIG. 14, the faceplate 335 includes a button 333 and a light pipe 336. The button 333 and the light pipe 336 may have various profiles that may or may not match the profile of the faceplate 335. The light pipe 336 may comprise any suitable material, including, without limitation, transparent plastic, that is capable of allowing light produced within the doorbell 330 to pass through. The light may be produced by one or more light-emitting components, such as light-emitting diodes (LED's), contained within the doorbell 330, as further described below. The button 333 may make contact with a button actuator (not shown) located within the doorbell 330 when the button 333 is pressed by a visitor. When pressed, the button 333 may trigger one or more functions of the doorbell 330, as further described below.

With reference to FIGS. 3 and 4, the doorbell 330 further includes an enclosure 331 that engages the faceplate 335. In the illustrated embodiment, the enclosure 331 abuts an upper edge 335T (FIG. 14) of the faceplate 335, but in alternative embodiments one or more gaps between the enclosure 331 and the faceplate 335 may facilitate the passage of sound and/or light through the doorbell 330. The enclosure 331 may comprise any suitable material, but in some embodiments the material of the enclosure 331 preferably permits infrared light to pass through from inside the doorbell 330 to the environment and vice versa. The doorbell 330 further includes a lens 332. In some embodiments, the lens may comprise a Fresnel lens, which may be patterned to deflect incoming light into one or more infrared sensors located within the doorbell 330. The doorbell 330 further includes a camera 334, which captures video data when activated, as described below.

FIG. 15 is a rear view of the doorbell 330, according to an aspect of the present embodiments. As illustrated, the enclosure 331 may extend from the front of the doorbell 330 around to the back thereof and may fit snugly around a lip of the back plate 339. The back plate 339 may comprise any suitable material, including, without limitation, metals, such as brushed aluminum or stainless steel, metal alloys, or plastics. The back plate 339 protects the internal contents of the doorbell 330 and serves as an exterior rear surface of the doorbell 330. The faceplate 335 may extend from the front of the doorbell 330 and at least partially wrap around the back plate 339, thereby allowing a coupled connection between the faceplate 335 and the back plate 339. The back plate 339 may have indentations in its structure to facilitate the coupling.

With further reference to FIG. 15, spring contacts 340 may provide power to the doorbell 330 when mated with other conductive contacts connected to a power source. The spring contacts 340 may comprise any suitable conductive material, including, without limitation, copper, and may be capable of deflecting when contacted by an inward force, for example the insertion of a mating element. The doorbell 330 further comprises a connector 360, such as a micro-USB or other connector, whereby power and/or data may be supplied to and from the components within the doorbell 330. A reset button 359 may be located on the back plate 339, and may make contact with a button actuator (not shown) located within the doorbell 330 when the reset button 359 is pressed. When the reset button 359 is pressed, it may trigger one or more functions, as described below.

FIG. 16 is a right side cross-sectional view of the doorbell 330 without the mounting bracket 337. In the illustrated embodiment, the lens 332 is substantially coplanar with the front surface 331F of the enclosure 331. In alternative embodiments, the lens 332 may be recessed within the enclosure 331 or may protrude outward from the enclosure 331. The camera 334 is coupled to a camera printed circuit board (PCB) 347, and a lens 334a of the camera 334 protrudes through an opening in the enclosure 331. The camera lens 334a may be a lens capable of focusing light into the camera 334 so that clear images may be taken.

The camera PCB 347 may be secured within the doorbell with any suitable fasteners, such as screws, or interference connections, adhesives, etc. The camera PCB 347 comprises various components that enable the functionality of the camera 334 of the doorbell 330, as described below. Infrared light-emitting components, such as infrared LED's 368, are coupled to the camera PCB 347 and may be triggered to activate when a light sensor detects a low level of ambient light. When activated, the infrared LED's 368 may emit infrared light through the enclosure 331 and/or the camera 334 out into the ambient environment. The camera 334, which may be configured to detect infrared light, may then capture the light emitted by the infrared LED's 368 as it reflects off objects within the camera's 334 field of view, so that the doorbell 330 can clearly capture images at night (may be referred to as “night vision”).

With continued reference to FIG. 16, the doorbell 330 further comprises a front PCB 346, which in the illustrated embodiment resides in a lower portion of the doorbell 330 adjacent a battery 366. The front PCB 346 may be secured within the doorbell 330 with any suitable fasteners, such as screws, or interference connections, adhesives, etc. The front PCB 346 comprises various components that enable the functionality of the audio and light components, as further described below. The battery 366 may provide power to the doorbell 330 components while receiving power from the spring contacts 340, thereby engaging in a trickle-charge method of power consumption and supply. Alternatively, the doorbell 330 may draw power directly from the spring contacts 340 while relying on the battery 366 only when the spring contacts 340 are not providing the power necessary for all functions. Still further, the battery 366 may comprise the sole source of power for the doorbell 330. In such embodiments, the spring contacts 340 may not be connected to a source of power. When the battery 366 is depleted of its charge, it may be recharged, such as by connecting a power source to the connector 360.

With continued reference to FIG. 16, the doorbell 330 further comprises a power PCB 348, which in the illustrated embodiment resides behind the camera PCB 347. The power PCB 348 may be secured within the doorbell 330 with any suitable fasteners, such as screws, or interference connections, adhesives, etc. The power PCB 348 comprises various components that enable the functionality of the power and device-control components, as further described below.

With continued reference to FIG. 16, the doorbell 330 further comprises a communication module 364 coupled to the power PCB 348. The communication module 364 facilitates communication with client devices in one or more remote locations, as further described below. The connector 360 may protrude outward from the power PCB 348 and extend through a hole in the back plate 339. The doorbell 330 further comprises passive infrared (PIR) sensors 344, which are secured on or within a PIR sensor holder 343, and the assembly resides behind the lens 332. In some embodiments, the doorbell 330 may comprise three PIR sensors 344, as further described below, but in other embodiments any number of PIR sensors 344 may be provided. The PIR sensor holder 343 may be secured to the doorbell 330 with any suitable fasteners, such as screws, or interference connections, adhesives, etc. The PIR sensors 344 may be any type of sensor capable of detecting and communicating the presence of a heat source within their field of view. Further, alternative embodiments may comprise one or more motion sensors either in place of or in addition to the PIR sensors 344. The motion sensors may be configured to detect motion using any methodology, such as a methodology that does not rely on detecting the presence of a heat source within a field of view.

FIG. 17 is an exploded view of the doorbell 330 and the mounting bracket 337 according to an aspect of the present embodiments. The mounting bracket 337 is configured to be mounted to a mounting surface (not shown) of a structure, such as a home or an office. FIG. 17 shows the front side 337F of the mounting bracket 337. The mounting bracket 337 is configured to be mounted to the mounting surface such that the back side 337B thereof faces the mounting surface. In certain embodiments, the mounting bracket 337 may be mounted to surfaces of various composition, including, without limitation, wood, concrete, stucco, brick, vinyl siding, aluminum siding, etc., with any suitable fasteners, such as screws, or interference connections, adhesives, etc. The doorbell 330 may be coupled to the mounting bracket 337 with any suitable fasteners, such as screws, or interference connections, adhesives, etc.

With continued reference to FIG. 17, the illustrated embodiment of the mounting bracket 337 includes the terminal screws 338. The terminal screws 338 are configured to receive electrical wires adjacent the mounting surface of the structure upon which the mounting bracket 337 is mounted, so that the doorbell 330 may receive electrical power from the structure's electrical system. The terminal screws 338 are electrically connected to electrical contacts 377 of the mounting bracket. If power is supplied to the terminal screws 338, then the electrical contacts 377 also receive power through the terminal screws 338. The electrical contacts 377 may comprise any suitable conductive material, including, without limitation, copper, and may protrude slightly from the face of the mounting bracket 337 so that they may mate with the spring contacts 340 located on the back plate 339.

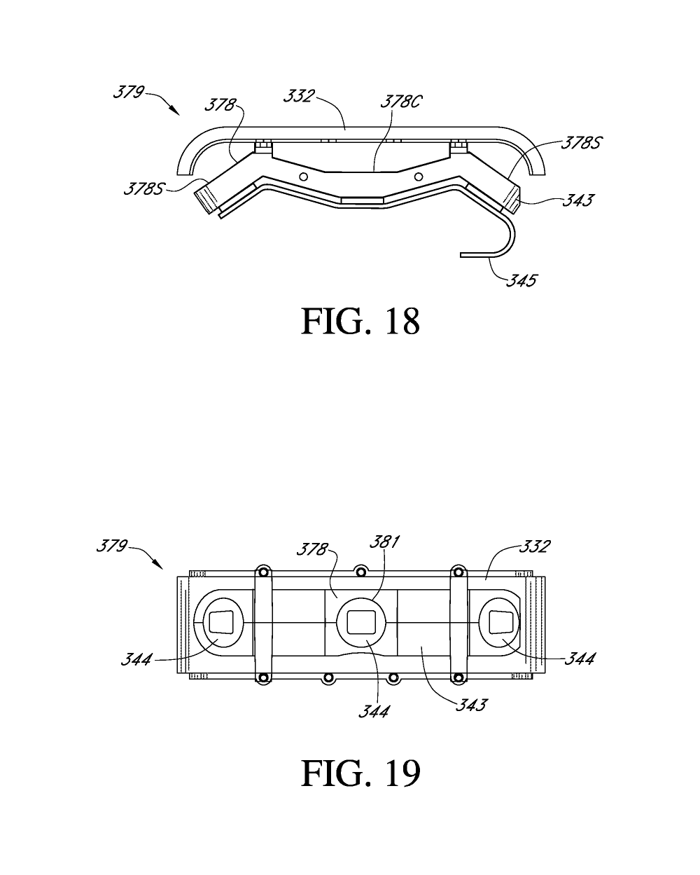

With continued reference to FIG. 17, the mounting bracket 337 further comprises a bracket PCB 349. The bracket PCB 349 is situated outside the doorbell 330, and is therefore configured for various sensors that measure ambient conditions, such as an accelerometer 350, a barometer 351, a humidity sensor 352, and a temperature sensor 353 (FIG. 18). The functions of these components are discussed in more detail below. The bracket PCB 349 may be secured to the mounting bracket 337 with any suitable fasteners, such as screws, or interference connections, adhesives, etc.

With continued reference to FIG. 17, the faceplate 335 may extend from the bottom of the doorbell 330 up to just below the camera 334, and connect to the back plate 339 as described above. The lens 332 may extend and curl partially around the side of the doorbell 330. The enclosure 331 may extend and curl around the side and top of the doorbell 330, and may be coupled to the back plate 339 as described above. The camera 334 may protrude slightly through the enclosure 331, thereby giving it a wider field of view. The mounting bracket 337 may couple with the back plate 339 such that they contact each other at various points in a common plane of contact, thereby creating an assembly including the doorbell 330 and the mounting bracket 337. The couplings described in this paragraph, and elsewhere, may be secured by, for example and without limitation, screws, interference fittings, adhesives, or other fasteners. Interference fittings may refer to a type of connection where a material relies on pressure and/or gravity coupled with the material's physical strength to support a connection to a different element.

FIG. 18 is a top view and FIG. 19 is a front view of a passive infrared sensor assembly 179 including the lens 132, the passive infrared sensor holder 143, the passive infrared sensors 144, and a flexible power circuit 145. The passive infrared sensor holder 143 is configured to mount the passive infrared sensors 144 facing out through the lens 132 at varying angles, thereby allowing the passive infrared sensor 144 field of view to be expanded to 180° or more and also broken up into various zones, as further described below. The passive infrared sensor holder 143 may include one or more faces 178, including a center face 178C and two side faces 178S to either side of the center face 178C. With reference to FIG. 19, each of the faces 178 defines an opening 181 within or on which the passive infrared sensors 144 may be mounted. In alternative embodiments, the faces 178 may not include openings 181, but may instead comprise solid flat faces upon which the passive infrared sensors 144 may be mounted. Generally, the faces 178 may be any physical structure capable of housing and/or securing the passive infrared sensors 144 in place.

With reference to FIG. 18, the passive infrared sensor holder 143 may be secured to the rear face of the lens 132. The flexible power circuit 145 may be any material or component capable of delivering power and/or data to and from the passive infrared sensors 144, and may be contoured to conform to the non-linear shape of the passive infrared sensor holder 143. The flexible power circuit 145 may connect to, draw power from, and/or transmit data to and from, the power printed circuit board 148.

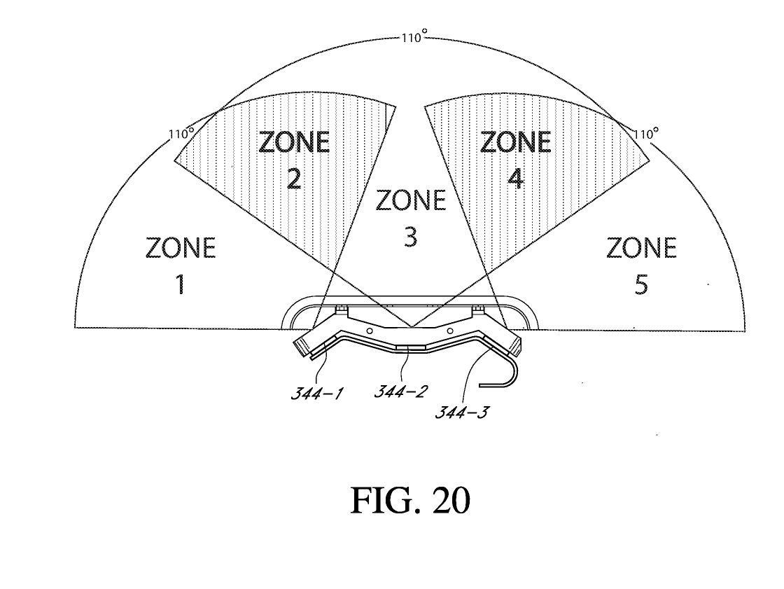

FIG. 20 is a top view of the passive infrared sensor assembly 179 illustrating the fields of view of the passive infrared sensors 144. In the illustrated embodiment, the side faces 178S of the passive infrared sensor holder 143 are angled at 55° facing outward from the center face 178C, and each passive infrared sensor 144 has a field of view of 110°. However, these angles may be increased or decreased as desired. Zone 1 is the area that is visible only to a first one of the passive infrared sensors 144-1. Zone 2 is the area that is visible only to the first passive infrared sensor 144-1 and a second one of the passive infrared sensors 144-2. Zone 3 is the area that is visible only to the second passive infrared sensor 144-2. Zone 4 is the area that is visible only to the second passive infrared sensor 144-2 and a third one of the passive infrared sensors 144-3. Zone 5 is the area that is visible only to the third passive infrared sensor 144-3. In some embodiments, the doorbell 130 may be capable of determining the direction that an object is moving based upon which zones are triggered in a time sequence.

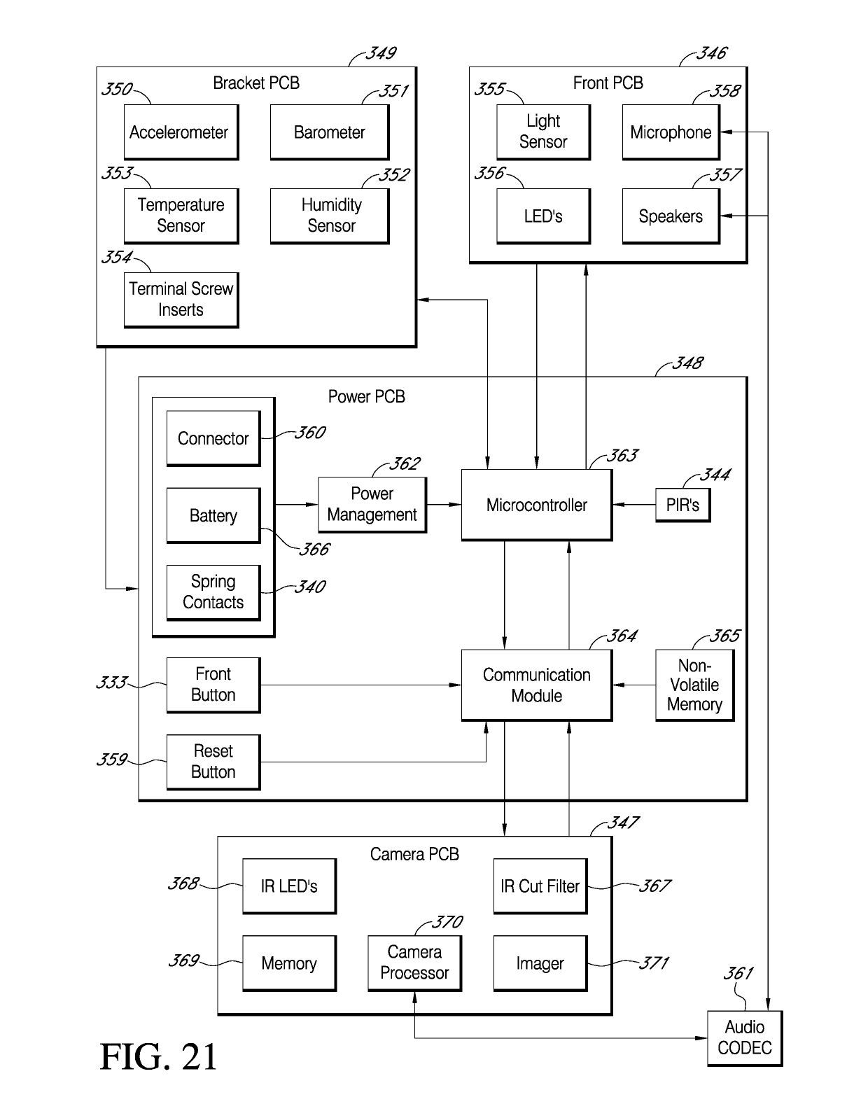

FIG. 21 is a functional block diagram of the components within or in communication with the doorbell 330, according to an aspect of the present embodiments. As described above, the bracket PCB 349 may comprise an accelerometer 350, a barometer 351, a humidity sensor 352, and a temperature sensor 353. The accelerometer 350 may be one or more sensors capable of sensing motion and/or acceleration. The barometer 351 may be one or more sensors capable of determining the atmospheric pressure of the surrounding environment in which the bracket PCB 349 may be located. The humidity sensor 352 may be one or more sensors capable of determining the amount of moisture present in the atmospheric environment in which the bracket PCB 349 may be located. The temperature sensor 353 may be one or more sensors capable of determining the temperature of the ambient environment in which the bracket PCB 349 may be located. As described above, the bracket PCB 349 may be located outside the housing of the doorbell 330 so as to reduce interference from heat, pressure, moisture, and/or other stimuli generated by the internal components of the doorbell 330.

With further reference to FIG. 21, the bracket PCB 349 may further comprise terminal screw inserts 354, which may be configured to receive the terminal screws 338 and transmit power to the electrical contacts 377 on the mounting bracket 337 (FIG. 17). The bracket PCB 349 may be electrically and/or mechanically coupled to the power PCB 348 through the terminal screws 338, the terminal screw inserts 354, the spring contacts 340, and the electrical contacts 377. The terminal screws 338 may receive electrical wires located at the surface to which the doorbell 330 is mounted, such as the wall of a building, so that the doorbell can receive electrical power from the building's electrical system. Upon the terminal screws 338 being secured within the terminal screw inserts 354, power may be transferred to the bracket PCB 349, and to all of the components associated therewith, including the electrical contacts 377. The electrical contacts 377 may transfer electrical power to the power PCB 348 by mating with the spring contacts 340.

With further reference to FIG. 21, the front PCB 346 may comprise a light sensor 355, one or more light-emitting components, such as LED's 356, one or more speakers 357, and a microphone 358. The light sensor 355 may be one or more sensors capable of detecting the level of ambient light of the surrounding environment in which the doorbell 330 may be located. LED's 356 may be one or more light-emitting diodes capable of producing visible light when supplied with power. The speakers 357 may be any electromechanical device capable of producing sound in response to an electrical signal input. The microphone 358 may be an acoustic-to-electric transducer or sensor capable of converting sound waves into an electrical signal. When activated, the LED's 356 may illuminate the light pipe 336 (FIG. 14). The front PCB 346 and all components thereof may be electrically coupled to the power PCB 348, thereby allowing data and/or power to be transferred to and from the power PCB 348 and the front PCB 346.

The speakers 357 and the microphone 358 may be coupled to the camera processor 370 through an audio CODEC 361. For example, the transfer of digital audio from the user's client device 114 and the speakers 357 and the microphone 358 may be compressed and decompressed using the audio CODEC 361, coupled to the camera processor 370. Once compressed by audio CODEC 361, digital audio data may be sent through the communication module 364 to the network 112, routed by one or more servers 118, and delivered to the user's client device 114. When the user speaks, after being transferred through the network 112, digital audio data is decompressed by audio CODEC 361 and emitted to the visitor via the speakers 357.

With further reference to FIG. 21, the power PCB 348 may comprise a power management module 362, a microcontroller 363 (may also be referred to as “processor,” “CPU,” or “controller”), the communication module 364, and power PCB non-volatile memory 365. In certain embodiments, the power management module 362 may comprise an integrated circuit capable of arbitrating between multiple voltage rails, thereby selecting the source of power for the doorbell 330. The battery 366, the spring contacts 340, and/or the connector 360 may each provide power to the power management module 362. The power management module 362 may have separate power rails dedicated to the battery 366, the spring contacts 340, and the connector 360. In one aspect of the present disclosure, the power management module 362 may continuously draw power from the battery 366 to power the doorbell 330, while at the same time routing power from the spring contacts 340 and/or the connector 360 to the battery 366, thereby allowing the battery 366 to maintain a substantially constant level of charge. Alternatively, the power management module 362 may continuously draw power from the spring contacts 340 and/or the connector 360 to power the doorbell 330, while only drawing from the battery 366 when the power from the spring contacts 340 and/or the connector 360 is low or insufficient. Still further, the battery 366 may comprise the sole source of power for the doorbell 330. In such embodiments, the spring contacts 340 may not be connected to a source of power. When the battery 366 is depleted of its charge, it may be recharged, such as by connecting a power source to the connector 360. The power management module 362 may also serve as a conduit for data between the connector 360 and the microcontroller 363.

With further reference to FIG. 21, in certain embodiments the microcontroller 363 may comprise an integrated circuit including a processor core, memory, and programmable input/output peripherals. The microcontroller 363 may receive input signals, such as data and/or power, from the PIR sensors 344, the bracket PCB 349, the power management module 362, the light sensor 355, the microphone 358, and/or the communication module 364, and may perform various functions as further described below. When the microcontroller 363 is triggered by the PIR sensors 344, the microcontroller 363 may be triggered to perform one or more functions. When the light sensor 355 detects a low level of ambient light, the light sensor 355 may trigger the microcontroller 363 to enable “night vision,” as further described below. The microcontroller 363 may also act as a conduit for data communicated between various components and the communication module 364.

With further reference to FIG. 21, the communication module 364 may comprise an integrated circuit including a processor core, memory, and programmable input/output peripherals. The communication module 364 may also be configured to transmit data wirelessly to a remote network device, and may include one or more transceivers (not shown). The wireless communication may comprise one or more wireless networks, such as, without limitation, Wi-Fi, cellular, Bluetooth, and/or satellite networks. The communication module 364 may receive inputs, such as power and/or data, from the camera PCB 347, the microcontroller 363, the button 333, the reset button 359, and/or the power PCB non-volatile memory 365. When the button 333 is pressed, the communication module 364 may be triggered to perform one or more functions. When the reset button 359 is pressed, the communication module 364 may be triggered to erase any data stored at the power PCB non-volatile memory 365 and/or at the camera PCB memory 369. The communication module 364 may also act as a conduit for data communicated between various components and the microcontroller 363. The power PCB non-volatile memory 365 may comprise flash memory configured to store and/or transmit data. For example, in certain embodiments the power PCB non-volatile memory 365 may comprise serial peripheral interface (SPI) flash memory.

With further reference to FIG. 21, the camera PCB 347 may comprise components that facilitate the operation of the camera 334. For example, an imager 371 may comprise a video recording sensor and/or a camera chip. In one aspect of the present disclosure, the imager 371 may comprise a complementary metal-oxide semiconductor (CMOS) array, and may be capable of recording high definition (e.g., 1080p or better) video files. A camera processor 370 may comprise an encoding and compression chip. In some embodiments, the camera processor 370 may comprise a bridge processor. The camera processor 370 may process video recorded by the imager 371 and audio recorded by the microphone 358, and may transform this data into a form suitable for wireless transfer by the communication module 364 to a network. The camera PCB memory 369 may comprise volatile memory that may be used when data is being buffered or encoded by the camera processor 370. For example, in certain embodiments the camera PCB memory 369 may comprise synchronous dynamic random access memory (SD RAM). IR LED's 368 may comprise light-emitting diodes capable of radiating infrared light. IR cut filter 367 may comprise a system that, when triggered, configures the imager 371 to see primarily infrared light as opposed to visible light. When the light sensor 355 detects a low level of ambient light (which may comprise a level that impedes the performance of the imager 371 in the visible spectrum), the IR LED's 368 may shine infrared light through the doorbell 330 enclosure out to the environment, and the IR cut filter 367 may enable the imager 371 to see this infrared light as it is reflected or refracted off of objects within the field of view of the doorbell. This process may provide the doorbell 330 with the “night vision” function mentioned above.

As discussed above, one aspect of the present embodiments includes the realization that parcel theft is a serious problem. Parcel carriers frequently leave parcels near the front door of a home when no one answers the door at the time of delivery. These parcels are vulnerable to theft, as they are often clearly visible from the street. This problem has only gotten worse with the proliferation of online commerce, and is particularly common around major holidays when many consumers do their holiday shopping online. It would be advantageous, therefore, if parcels could be configured in a way that would discourage people from attempting to steal them.

One way to discourage people from attempting to steal parcels would be to place a tracking device in every parcel. A tracking device is a device that enables the location of the device to be determined and tracked from a location remote from the tracking device. If every parcel contained a tracking device, then it would be possible to locate, track, and recover stolen parcels, making parcels much less attractive to thieves. Placing a tracking device in every parcel, however, could be cost prohibitive, because of the added cost of the tracking device itself. When a parcel recipient receives a parcel, he or she typically removes the contents from the parcel container and then discards the container and any packing materials that may have been included to keep the parcel contents safe during transit. If the parcel contained a tracking device, it too would likely be discarded, leaving the shipping entity to bear the cost of the discarded tracking device. The cost associated with discarded tracking devices might be passed on to the consumer, but, regardless of which party (sender or recipient) bears the cost for discarded tracking devices, this scenario would substantially increase the cost for shipping goods, and is therefore likely not feasible.

The present embodiments solve this problem by providing parcel tracking devices that are self-addressed. The parcel tracking device bears an address, such as the address of the originating entity, and may in some embodiments also include postage or an indicator that postage for the return of the tracking device will be paid by the addressee. The recipient of the parcel thus needs only to place the self-addressed tracking device in any mailbox, and the tracking device will be returned to the originating entity. The originating entity can then reuse the self-addressed tracking device, thereby significantly lowering the cost of placing tracking devices in parcels. In some embodiments, the present self-addressed tracking devices may be included in every parcel. In other embodiments, the present self-addressed tracking devices may be included in only select parcels, such as a subset of a larger group of parcels. The subset of parcels may comprise, for example, only parcels associated with recipients who have requested that a self-addressed tracking device be included with their parcel. In another example, the parcel originator may include a self-addressed tracking device in every other parcel, or every third parcel, or every fourth parcel, or every fifth parcel, or at any other regular interval. In another example, the parcel originator may add self-addressed tracking devices to parcels according to a random process.

Some of the present embodiments also leverage the functionality of A/V recording and communication devices to deter parcel theft and/or to identify and apprehend parcel thieves. For example, in some embodiments an A/V recording and communication device may receive a first wireless transmission from a tracking device of a parcel. The A/V recording and communication device may then determine, based on the receipt of the first wireless transmission, that the parcel has been left near the location of the A/V recording and communication device. The A/V recording and communication device may subsequently receive a second wireless transmission from the tracking device of the parcel. The A/V recording and communication device may then determine, based on the receipt of the second wireless transmission, that the parcel has been removed from near the location of the A/V recording and communication device. The A/V recording and communication device may then determine whether the removal of the parcel was authorized and, if the removal was unauthorized, the A/V recording and communication device may generate an alert, such as an alert to a user's smartphone (or other type of client device).

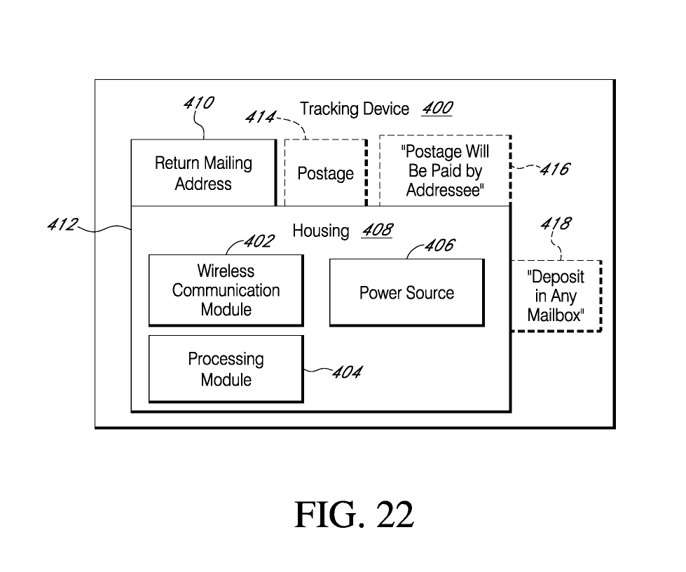

FIG. 22 is a functional block diagram of one embodiment of a self-addressed parcel tracking device 400 according to various aspects of the present disclosure. The illustrated tracking device 400 comprises at least a wireless communication module 402, a processing module 404, a power source 406, and a housing 408 for containing and/or protecting the components of the tracking device 400. In some embodiments, the wireless communication module 402, the processing module 404, and/or the power source 406 may be located at least partially within the housing 408. The processing module 404 is communicatively coupled to the wireless communication module 402, and the power source 406 is electrically coupled to the wireless communication module 402 and the processing module 404. In some embodiments, the tracking device 400 may further include an accelerometer (not shown) for movement detection.

The tracking device 400 may be a specially designed and built device, or may be an off-the-shelf type of device. The tracking device 400 may embody any currently known and/or later developed technology for locating an object. One non-limiting example of technology that may be used in the present embodiments is satellite navigation, such as GPS (Global Positioning System), GLONASS (Global Navigation Satellite System), or any other satellite navigation system. A satellite navigation system is a system that uses satellites to provide autonomous geo-spatial positioning. It allows small electronic receivers to determine their location, including longitude, latitude, and/or altitude/elevation, with high precision, such as within a few meters, using time signals transmitted along a line of sight by radio from satellites. The system can be used for navigation as well as for tracking the position of an object fitted with a receiver (satellite tracking).

With continued reference to FIG. 22, the wireless communication module 402 of the self-addressed parcel tracking device 400 may include one or more components for communicating wirelessly with one or more other devices, and/or may include one or more components for determining a location of the self-addressed parcel tracking device 400. For example, the wireless communication module 402 may include any or all of the following components (or any other components not listed): A subscriber identity module (SIM, also referred to as a subscriber identification module), a GPS (and/or GLONASS, and/or any other satellite navigation system) tracking unit, a GPS (and/or GLONASS, and/or any other satellite navigation system) beacon (for “data pusher” type devices), a GPS (and/or GLONASS, and/or any other satellite navigation system) transponder (for “data puller” type devices), a Bluetooth (or other short-range wireless communication protocol) transceiver, a cellular transceiver (compatible with any cellular communication technology, such as, but not limited to, Global System for Mobile Communications (GSM), General Packet Radio Service (GPRS), cdmaOne, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), Integrated Digital Enhanced Network (iDEN), etc.), and/or a radio frequency identification (RFID) tag.

A SIM is an integrated circuit that is intended to securely store the international mobile subscriber identity (IMSI) number and its related key, which are used to identify and authenticate subscribers on mobile telephony devices (such as mobile phones and computers).

A GPS tracking unit is a device, normally carried by a moving vehicle or person, that uses the Global Positioning System to determine and track its precise location, and hence that of its carrier, at intervals. The recorded location data can be stored within the tracking unit, or it may be transmitted to a central location database, or Internet-connected computer, using a cellular, radio, or satellite modem embedded in the unit. This allows the asset's location to be displayed against a map backdrop either in real time or when analyzing the track later, using GPS tracking software.

Data pushers are one type of GPS tracking unit, and are typically used for asset tracking. Also known as a GPS beacon, this kind of device pushes (e.g., sends) the position of the device, and may also send other information, such as speed or altitude, at regular intervals, to a server, which can store and analyze the data. In some data pushers, a GPS navigation device and a mobile phone sit side-by-side in the same box, powered by the same battery. At regular intervals, the phone sends a message, such as via SMS (Short Message Service) or GPRS, containing the data from the GPS receiver.

Data pullers are another type of GPS tracking unit, and are also known as GPS transponders. Unlike data pushers that send the position of the devices at regular intervals (push technology), data pullers are always on, and can be queried as often as required (pull technology). For example, a data puller may be sent a message, such as via SMS or GPRS, and may then reply to the message with its location. Data pullers are useful for cases where the location of the tracker will only need to be known occasionally. For example, data puller-type GPS tracking units can be placed in or on property that may be stolen, such as parcels.

GLONASS (Global Navigation Satellite System) is a space-based satellite navigation system operating in the radionavigation-satellite service and used by the Russian Aerospace Defence Forces. It provides an alternative to GPS, but may also be used in conjunction with GPS to leverage more satellites, meaning positions can be fixed more quickly and accurately, especially in built-up areas where the view to some GPS satellites may be obscured by buildings.

With reference to FIG. 22, the processing module 404 of the self-addressed parcel tracking device 400 may comprise a processor (not shown) for the execution of a program of instructions. The processor may be, for example, a general-purpose processor or a special-purpose processor, and may be supplemented by, or incorporated in, one or more ASICs (application-specific integrated circuits). The power source 406 of the self-addressed parcel tracking device 400 may comprise, for example, a battery (not shown), such as a rechargeable battery. The rechargeable battery is preferably configured to provide adequate power for the tracking device 400 for at least as long as the device 400 is expected to be in transit, such as up to a few days, or a week, or several weeks, or a month or more. The tracking device 400 may further comprise one or more components for facilitating recharging of the rechargeable battery, such as spring contacts (not shown), a charging port (such as a micro-USB port, not shown), and/or an induction coil (not shown) configured to enable inductive charging (also known as wireless charging) of the self- addressed parcel tracking device 400.

With reference to FIG. 22, the self-addressed parcel tracking device 400 further comprises a return mailing address 410 on an outer surface 412 of the housing 408. The return mailing address 410 may comprise a mailing address of an originator of a parcel, such that a recipient of the parcel may easily return the self-addressed tracking device 400 to the originator of the parcel by placing the self-addressed parcel tracking device 400 in a mailbox. The return mailing address 410 may be applied or affixed to the outer surface 412 of the housing 408 in any suitable fashion, such as by painting, printing, or stenciling, or with an adhesive label, for example.

To further facilitate return of the self-addressed tracking device 400 to the originator of the parcel, the self-addressed parcel tracking device 400 may further comprise postage 414, and/or an indicator 416 on the outer surface 412 of the housing 408 that postage for returning the self-addressed tracking device 400 to the originator will be paid by the addressee. In some embodiments, the addressee may be the originator of the parcel assembly, although in alternative embodiments the addressee may be a party or entity different from the originator of the parcel assembly, such as a third-party intermediary. To further facilitate return of the self-addressed tracking device 400 to the originator of the parcel, the self-addressed parcel tracking device 400 may further comprise an indicator 418 or instructions on the outer surface 412 of the housing 408 to return the self-addressed tracking device 400 by depositing it in any mailbox.

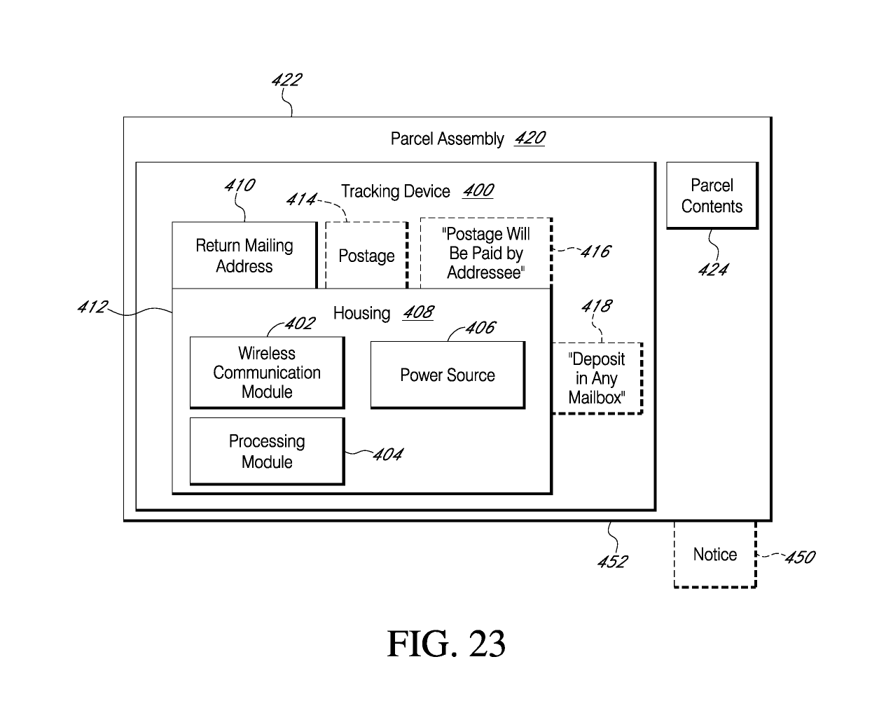

FIG. 23 is a functional block diagram of one embodiment of a parcel assembly 420 including a self-addressed parcel tracking device 400 according to various aspects of the present disclosure. The parcel assembly 420 includes a container 422 for containing and protecting parcel contents 424 during transit of the parcel assembly 420, and at least one self-addressed parcel tracking device 400. The container 422 may comprise any structure, such as a box, a carton, a crate, an envelope, or a pouch, suitable for shipping at least one item (the “parcel contents 424”) from an originator to a recipient. For example, the parcel assembly 420 may originate with a retailer, who may receive an order from a customer for a retail item. The retailer may then retrieve the ordered item from stock, place the item in the container 422 together with at least one self-addressed parcel tracking device 400, seal the container 422, and ship the parcel 420 to the customer (or transfer the parcel 420 to a third-party shipper, who may ship the parcel 420 to the customer).

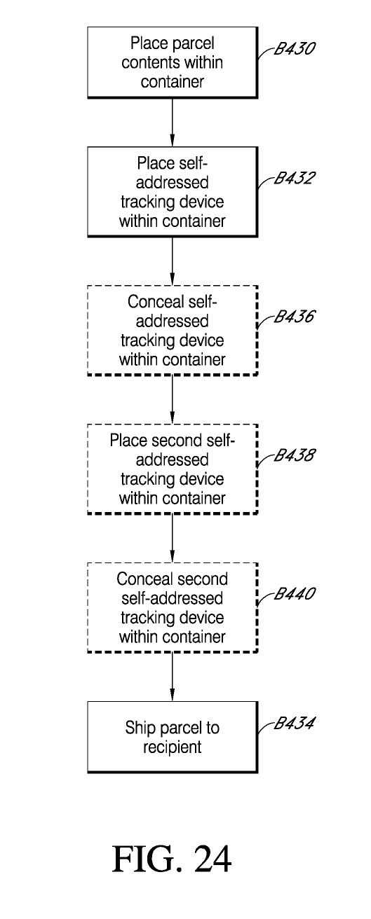

FIG. 24 is a flowchart illustrating one embodiment of a process for including a self-addressed parcel tracking device 400 in a parcel 420 according to various aspects of the present disclosure. At block B430, the originator of the parcel 420 may place the parcel contents 424 in the container 422. As described above, the parcel contents 424 may comprise one or more retail items, but in other embodiments the parcel contents 424 may comprise anything capable of being placed into a container 422 and sent from an originator to a recipient. At block B432, the originator of the parcel 420 may place at least one self-addressed parcel tracking device 400 in the container 422. At block B434, the originator of the parcel 420 may ship the parcel 420 to the recipient, which may in some embodiments comprise transferring the parcel 420 to a third-party shipper, who may ship the parcel 420 to the recipient.

In some embodiments, the originator of the parcel 420 may conceal the self-addressed parcel tracking device 400 within the container 422, as shown at block B436. For example, the tracking device 400 may be hidden among packing materials within the container 422. Concealing the tracking device 400 within the container 422 may increase the chances of apprehending a parcel thief, who may be unaware that the parcel 420 he or she has stolen contains a tracking device 400. If the parcel thief does not know that the parcel 420 he or she has stolen contains a tracking device 400, he or she may delay in separating the parcel contents 424 from the parcel 420, which may provide additional time for tracking and locating the parcel 420 and the parcel thief. To further enhance the likelihood of apprehending a parcel thief, the originator of the parcel 420 may, in some embodiments, place at least a second self-addressed parcel tracking device 400 in the container 422 (block B438) and conceal the second self-addressed parcel tracking device 400 within the container 422, as shown at block B440. The second tracking device 400 may further enhance the likelihood of apprehending a parcel thief by creating a false sense of security for the parcel thief once the parcel thief has removed one, but not the other, of the two tracking devices 400 from the container 422. While the process of FIG. 24 includes one or more self-addressed parcel tracking devices 400, in alternative embodiments in which the tracking device(s) 400 is/are hidden within the container 422, the tracking device(s) 400 may not be self-addressed.

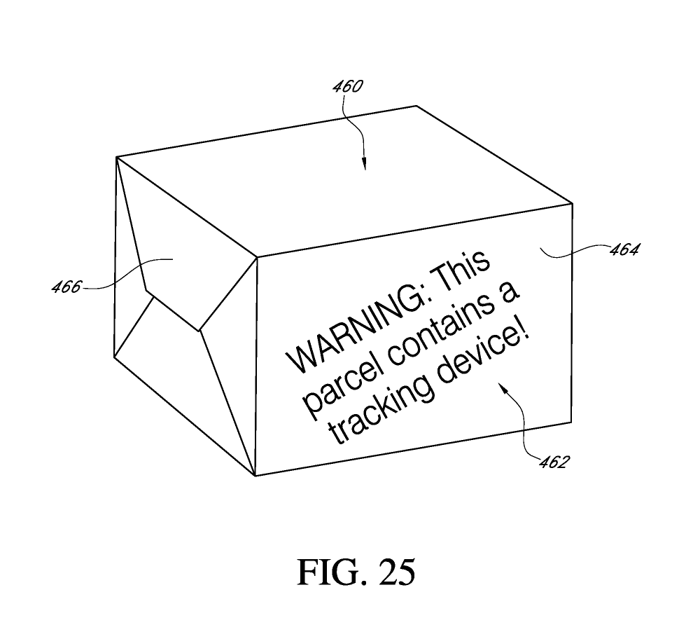

In some embodiments, the parcel assembly 420 may further comprise a notice 450 on an outer surface 452 of the container 422, wherein the notice 450 indicates that the parcel assembly 420 contains an anti-theft device, such as a tracking device 400. For example, FIG. 25 is a side perspective view of one embodiment of a parcel 460 including a warning 462 on an outer surface 464 that the parcel 460 contains a tracking device 400. In the illustrated embodiment, the parcel 460 includes an outer paper wrapper 466, and the warning 462 is provided on the outer paper wrapper 466. The illustrated embodiment, however, is not intended to be limiting, and in alternative embodiments the warning 462 may be provided directly on the exterior surface 452 of the container 422. The warning 462 advantageously puts would-be parcel thieves on notice that the parcel 420, 460 contains a device that makes it more likely that the thief would be apprehended if he or she attempted to steal the parcel 420, 460 thereby deterring theft of the parcel 420, 460.

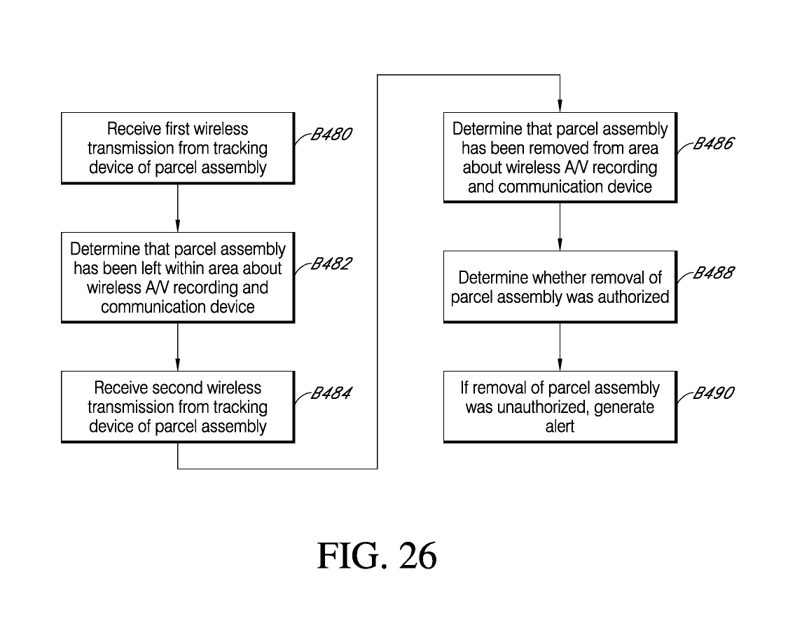

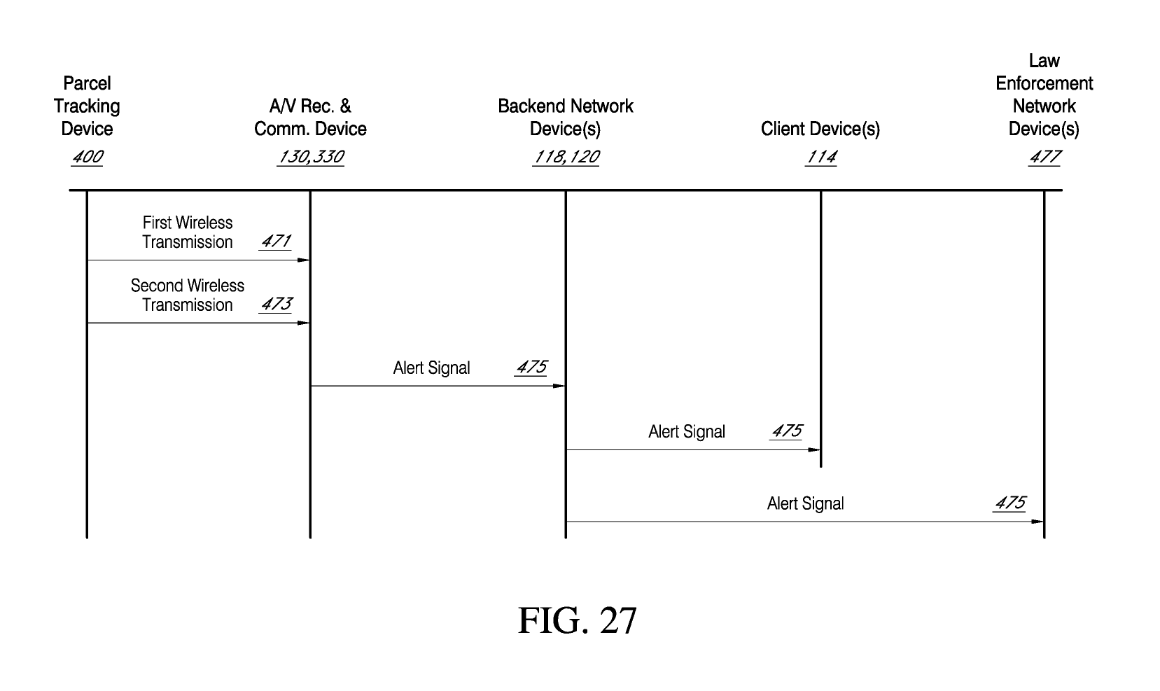

Some of the present embodiments may include leveraging the capabilities of an A/V recording and communication device, such as an A/V recording and communication doorbell, to deter parcel theft and/or to facilitate tracking of stolen parcels and/or apprehension of parcel thieves. For example, FIG. 26 is a flowchart illustrating one embodiment of a process for protecting a parcel 420 from theft using a tracking device 400 and an A/V recording and communication device, and FIG. 27 is a sequence diagram illustrating the same process. In one non-limiting example, the A/V recording and communication device may comprise an A/V recording and communication doorbell, such as any of the doorbells 130, 330 described herein. The parcel 420 may include a container 422 and a tracking device 400 within the container 422, and the process may commence when the parcel 420 is left in a vicinity of the A/V recording and communication device. In one non-limiting example, the parcel 420 may be delivered by a parcel 420 carrier and left near the front door of a home.

With reference to FIG. 26, the process may comprise, at block B470, receiving a first wireless transmission from the tracking device 400 of the parcel assembly 420. For example, the first wireless transmission 471 may be received by the A/V recording and communication device 130, 330 using a wireless communication module of the A/V recording and communication device 130, 330, as indicated in FIG. 27. At block B472, the process may further comprise determining, by the A/V recording and communication device 130, 330, based on the receipt of the first wireless transmission 471, that the parcel assembly 420 has been left within an area about the A/V recording and communication device 130, 330. For example, when the parcel assembly 420 is left within the area about the A/V recording and communication device 130, 330, the communication module of the A/V recording and communication device 130, 330 may detect a signal from the tracking device 400. Based on the receipt of the signal, the A/V recording and communication device 130, 330 may determine that the parcel assembly 420 is present (e.g., within a communication range of the A/V recording and communication device 130, 330).

In some embodiments, the first wireless transmission 471 from the tracking device 400 may comprise a signal from a radio frequency identification (RFID) tag of the tracking device 400. RFID uses electromagnetic fields to automatically identify and track tags attached to objects. The tags contain electronically stored information, and may be passive or active. Passive tags collect energy from a nearby RFID reader's interrogating radio waves. Active tags have a local power source, such as a battery, and may operate at hundreds of meters from the RFID reader. The A/V recording and communication device 130, 330 may include an RFID reader (not shown), which may receive a signal from the RFID tag of the tracking device 400. In some embodiments, the signal from the RFID tag of the tracking device 400 may be sent in response to an interrogating signal from the A/V recording and communication device 130, 330. In other embodiments, the signal from the RFID tag of the tracking device 400 may be sent at regular intervals, with or without first receiving an interrogating signal from the A/V recording and communication device 130, 330. The A/V recording and communication device 130, 330 may capture information embedded in the RFID tag, and may take one or more actions in response to determining that the parcel assembly 420 has been left within the area about the A/V recording and communication device 130, 330. For example, the A/V recording and communication device 130, 330 may transmit a notification, such as a push notification, to a client device 114 to inform a user that his or her parcel 420 has arrived. The push notification may be sent via one or more backend devices, such as servers 118, API's 120, and the like (FIG. 1).

With continued reference to FIG. 26, the process may further comprise, at block B474, receiving a second wireless transmission from the tracking device 400 of the parcel assembly 420. For example, the second wireless transmission 473 may be received by the A/V recording and communication device 130, 330 using a wireless communication module of the A/V recording and communication device 130, 330, as indicated in FIG. 27. For example, as described above, the RFID tag of the tracking device 400 may be configured to send signals at regular intervals, and the A/V recording and communication device 130, 330 may receive these signals. In another example, the A/V recording and communication device 130, 330 may send one or more interrogating signals, and may receive response signals from the RFID tag of the tracking device 400. The process may then further comprise, at block B476, determining, by the A/V recording and communication device 130, 330, based on the receipt of the second wireless transmission 473, that the parcel assembly 420 has been removed from the area about the A/V recording and communication device 130, 330. For example, the A/V recording and communication device 130, 330 may determine from the second wireless transmission 473 that the parcel assembly 420 is now farther away from the A/V recording and communication device 130, 330 than it was when the first wireless transmission 471 was received. The distance between the parcel assembly 420 and the A/V recording and communication device 130, 330 may be determined based on the strength of the signal from the tracking device 400, for example, or by any other method.

In another example, the A/V recording and communication device 130, 330 may determine that the parcel assembly 420 has been removed from the area about the A/V recording and communication device 130, 330 because an RFID reader of the A/V recording and communication device 130, 330 may detect that the regularly repeating signals from the RFID tag of the tracking device 400 have stopped, or that the RFID tag no longer responds to interrogation signals sent by the A/V recording and communication device 130, 330. In some embodiments, if the RFID reader sends a threshold number of interrogation signals and receives no response from the RFID tag of the parcel assembly 420, the process may determine that the parcel assembly 420 has been removed from the area about the A/V recording and communication device 130, 330. In some embodiments, the threshold number of interrogation signals with no response may be one interrogation signal, or two interrogation signals, or three interrogation signals, or any other number of interrogation signals.

With continued reference to FIG. 26, the process may further comprise, at block B478, determining, by the A/V recording and communication device 130, 330, whether removal of the parcel assembly 420 from the area about the A/V recording and communication device 130, 330 was authorized. In some embodiments, determining whether removal of the parcel assembly 420 from the area about the A/V recording and communication device 130, 330 was authorized may comprise determining a direction of movement of the parcel assembly 420. For example, if the parcel assembly 420 is moved into the structure (e.g., a house) at which the A/V recording and communication device 130, 330 is located, then it may be likely that removal of the parcel assembly 420 was authorized, but if the parcel assembly 420 is moved away from the structure at which the A/V recording and communication device 130, 330 is located, then it may be likely that removal of the parcel assembly 420 was not authorized. In another example embodiment, geo-fencing may be set up so that the parcel assembly 420 may be determined to have been stolen (removal unauthorized) if the parcel assembly 420 exits a defined boundary. In another example embodiment, an accelerometer (or other motion detection device) of the tracking device 400 may determine that the parcel 420 is in motion, and the tracking device 400 may then send a signal to the A/V recording and communication device 130, 330 indicating that the parcel 420 is in motion. The A/V recording and communication device 130, 330 may then determine whether removal of the parcel assembly 420 from the area about the A/V recording and communication device 130, 330 was authorized.

With continued reference to FIG. 26, the process may further comprise, at block B480, generating, by the A/V recording and communication device 130, 330, an alert when the removal of the parcel assembly 420 from the area about the A/V recording and communication device 130, 330 is determined to have been unauthorized. The alert may comprise, for example, a push notification transmitted to a client device 114 associated with the A/V recording and communication device 130, 330. The push notification may be sent in an alert signal 475 via one or more backend network devices, such as servers 118, API's 120, and the like, as indicated in FIG. 27. In another example, the alert may comprise a notification sent to a network device 477 associated with a law enforcement agency. The notification may be sent in an alert signal 475 via one or more backend devices, such as servers 118, API's 120, and the like, as indicated in FIG. 27. Once a parcel assembly 420 is determined to have been stolen, its location may be viewed on a map displayed on a client device, such as a smartphone, and the owner of the parcel 420 and/or law enforcement may attempt to recover the stolen parcel 420.

The present embodiments further include one or more methods of placing self-addressed tracking devices 400 in selected parcels 420. For example, a parcel originator may assemble a plurality of parcel assemblies 420 by placing parcel contents 424 within each one of a plurality of containers 422. Each of the containers 422 may comprise, for example, a box, a carton, a crate, an envelope, a pouch, or any other type of container. The parcel originator may be, for example, a retailer, and the process of assembling multiple parcel assemblies 420 may occur, for example, in connection with fulfilling orders for retail products from multiple customers. Assembling the parcel assemblies 420 may further comprise placing a self-addressed parcel tracking device within a subset of the plurality of containers 422, wherein the subset of the plurality of containers 422 includes some, but not all, of the plurality of containers 422. The self-addressed parcel tracking devices may comprise any of the self-addressed parcel tracking devices described herein, such as the self-addressed parcel tracking device 400 shown in FIG. 22, for example.

The present embodiments contemplate numerous methods and/or criteria for determining in which containers 422 out of the plurality of containers 422 to place a self-addressed parcel tracking device 400. For example, in one implementation the containers 422 that receive a self-addressed parcel tracking device 400 may be selected randomly. In another example implementation, self-addressed parcel tracking devices 400 may be placed in the containers 422 at regular intervals, such as every other container 422, or every third container 422, or every fourth container 422, or every fifth container 422, or at any other regular interval. In this example implementation, the determination of which containers 422 comprise every other container 422, or every third container 422, etc., may be made at a fixed point in a parcel assembly line, such that as each container 422 passes the fixed point the process counts the passing containers 422 and places a self-addressed parcel tracking device 400 in selected containers 422 according to the set interval.

In another example implementation, a self-addressed parcel tracking device 400 may be placed in only the containers 422 that are destined for customers who have requested that their order include a tracking device. For example, as discussed above, the parcel originator may be a retailer, and the process of assembling multiple parcel assemblies 420 may occur, for example, in connection with fulfilling orders for retail products from multiple customers. Some of these customers may request that their order include a tracking device for added security against theft. Self-addressed parcel tracking devices 400 may then be placed in only the containers 422 destined for customers who have made a request for a tracking device. In some embodiments, when a customer requests a tracking device, the parcel originator (e.g., a retailer) may request that the customer pay a deposit for the requested tracking device. The deposit may help defray the cost of the tracking device in the event the customer fails to return it to the parcel originator. When a tracking device deposit payment is requested, the present embodiments may further include receiving the requested deposit payment from the customer, and may further include refunding the received deposit payment to the customer after the tracking device 400 is returned to the parcel originator.

As discussed above in connection with FIG. 25, some of the present embodiments may comprise a notice 450 (e.g., a warning 462) on an outer surface 452, 464 of a parcel assembly 420, 460 wherein the notice 450 indicates that the parcel assembly 420, 460 contains an anti-theft device (e.g., a tracking device 400). Thus, some of the present embodiments may comprise applying such a notice 450, 462 on an outer surface 452, 464 of at least some parcel assemblies 420, 460. For example, in some embodiments the notice 450, 462 may be provided only on those parcel assemblies 420, 460 that actually contain a tracking device 400. Thus, some of the present embodiments may comprise applying the notice 450, 462 to only selected parcel assemblies 420, 460, wherein the selected parcel assemblies 420, 460 are those in which a tracking device 400 is also placed. In other example embodiments, the notice 450, 462 may be provided on every parcel assembly generated by the parcel assembly originator, regardless of whether every parcel assembly actually contains a tracking device. And, in some example embodiments, the notice 450, 462 may be provided on every parcel assembly 420, 460 generated by the parcel assembly originator, even when none of the parcel assemblies 420, 460 actually contains a tracking device 400. The notices 450, 462 on the outer surfaces 452, 464 of a parcel assemblies 420, 460 advantageously provide deterrence against parcel theft, even with respect to parcel assemblies 420, 460 that don't actually contain a tracking device, because parcel thieves cannot know whether a given parcel actually contains a tracking device without opening the parcel.

As discussed above, the present disclosure provides numerous examples of methods and systems including A/V recording and communication doorbells, but the present embodiments are equally applicable for A/V recording and communication devices other than doorbells. For example, the present embodiments may include one or more A/V recording and communication security cameras instead of, or in addition to, one or more A/V recording and communication doorbells. An example A/V recording and communication security camera may include substantially all of the structure and functionality of the doorbell 130, but without the front button 148, the button actuator 228, and/or the light pipe 232.

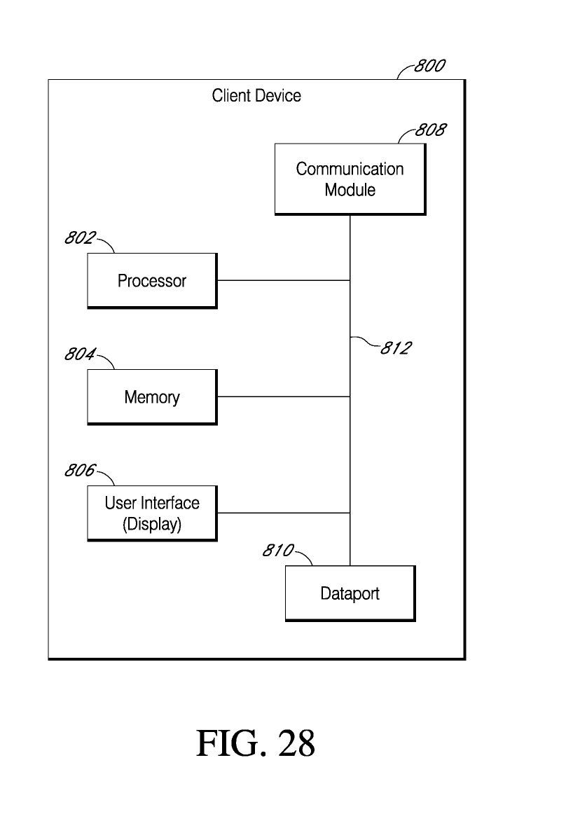

FIG. 28 is a functional block diagram of a client device 800 on which the present embodiments may be implemented according to various aspects of the present disclosure. The user's client device 114 described with reference to FIG. 1 may include some or all of the components and/or functionality of the client device 800. The client device 800 may comprise, for example, a smartphone.

With reference to FIG. 28, the client device 800 includes a processor 802, a memory 804, a user interface 806, a communication module 808, and a dataport 810. These components are communicatively coupled together by an interconnect bus 812. The processor 802 may include any processor used in smartphones and/or portable computing devices, such as an ARM processor (a processor based on the RISC (reduced instruction set computer) architecture developed by Advanced RISC Machines (ARM).). In some embodiments, the processor 802 may include one or more other processors, such as one or more conventional microprocessors, and/or one or more supplementary co-processors, such as math co-processors.

The memory 804 may include both operating memory, such as random access memory (RAM), as well as data storage, such as read-only memory (ROM), hard drives, flash memory, or any other suitable memory/storage element. The memory 804 may include removable memory elements, such as a CompactFlash card, a MultiMediaCard (MMC), and/or a Secure Digital (SD) card. In some embodiments, the memory 804 may comprise a combination of magnetic, optical, and/or semiconductor memory, and may include, for example, RAM, ROM, flash drive, and/or a hard disk or drive. The processor 802 and the memory 804 each may be, for example, located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 802 may be connected to the memory 804 via the dataport 810.

The user interface 806 may include any user interface or presentation elements suitable for a smartphone and/or a portable computing device, such as a keypad, a display screen, a touchscreen, a microphone, and a speaker. The communication module 808 is configured to handle communication links between the client device 800 and other, external devices or receivers, and to route incoming/outgoing data appropriately. For example, inbound data from the dataport 810 may be routed through the communication module 808 before being directed to the processor 802, and outbound data from the processor 802 may be routed through the communication module 808 before being directed to the dataport 810. The communication module 808 may include one or more transceiver modules capable of transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, or any other protocol and/or technology.

The dataport 810 may be any type of connector used for physically interfacing with a smartphone and/or a portable computing device, such as a mini-USB port or an IPHONE®/IPOD® 30-pin connector or LIGHTNING® connector. In other embodiments, the dataport 810 may include multiple communication channels for simultaneous communication with, for example, other processors, servers, and/or client terminals.

The memory 804 may store instructions for communicating with other systems, such as a computer. The memory 804 may store, for example, a program (e.g., computer program code) adapted to direct the processor 802 in accordance with the present embodiments. The instructions also may include program elements, such as an operating system. While execution of sequences of instructions in the program causes the processor 802 to perform the process steps described herein, hard-wired circuitry may be used in place of, or in combination with, software/firmware instructions for implementation of the processes of the present embodiments. Thus, the present embodiments are not limited to any specific combination of hardware and software.

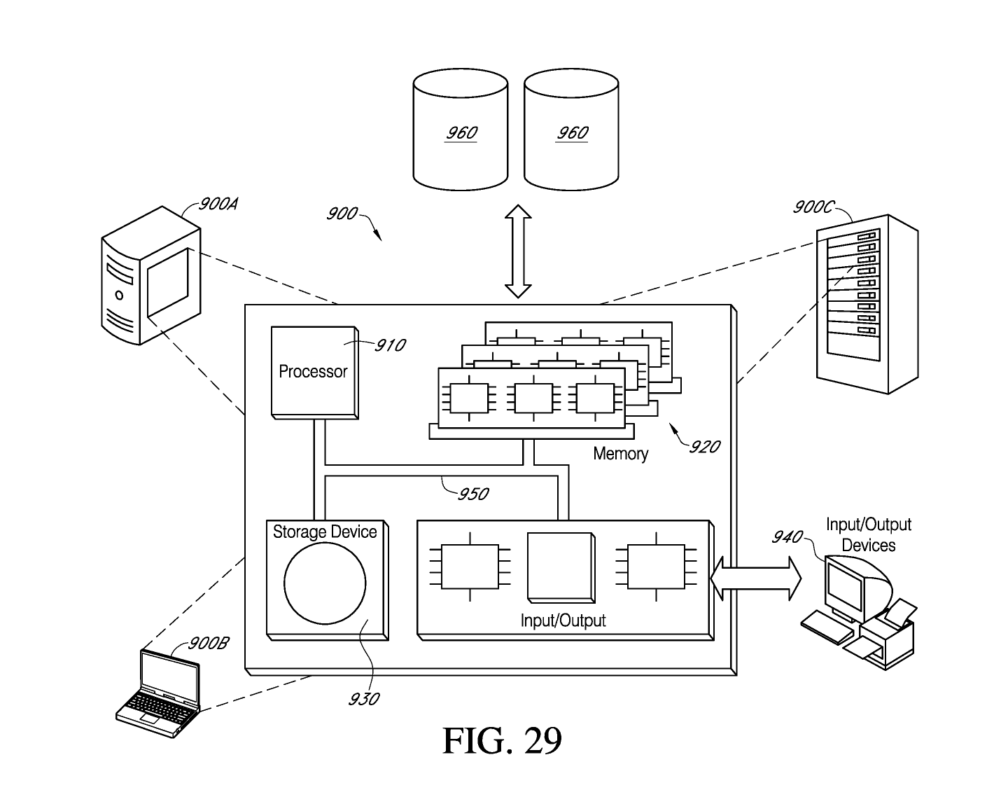

FIG. 29 is a functional block diagram of a general-purpose computing system on which the present embodiments may be implemented according to various aspects of present disclosure. The computer system 900 may execute at least some of the operations described above. The computer system 900 may be embodied in at least one of a personal computer (also referred to as a desktop computer) 900A, a portable computer (also referred to as a laptop or notebook computer) 900B, and/or a server 900C. A server is a computer program and/or a machine that waits for requests from other machines or software (clients) and responds to them. A server typically processes data. The purpose of a server is to share data and/or hardware and/or software resources among clients. This architecture is called the client-server model. The clients may run on the same computer or may connect to the server over a network. Examples of computing servers include database servers, file servers, mail servers, print servers, web servers, game servers, and application servers. The term server may be construed broadly to include any computerized process that shares a resource to one or more client processes.

The computer system 900 may include at least one processor 910, memory 920, at least one storage device 930, and input/output (I/O) devices 940. Some or all of the components 910, 920, 930, 940 may be interconnected via a system bus 950. The processor 910 may be single- or multi-threaded and may have one or more cores. The processor 910 may execute instructions, such as those stored in the memory 920 and/or in the storage device 930. Information may be received and output using one or more I/O devices 940.

The memory 920 may store information, and may be a computer-readable medium, such as volatile or non-volatile memory. The storage device(s) 930 may provide storage for the system 900, and may be a computer-readable medium. In various aspects, the storage device(s) 930 may be a flash memory device, a hard disk device, an optical disk device, a tape device, or any other type of storage device.

The I/O devices 940 may provide input/output operations for the system 900. The I/O devices 940 may include a keyboard, a pointing device, and/or a microphone. The I/O devices 940 may further include a display unit for displaying graphical user interfaces, a speaker, and/or a printer. External data may be stored in one or more accessible external databases 960.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application-specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A parcel assembly, comprising:
a container;
parcel contents within the container; and
a self-addressed tracking device within the container, wherein the self-addressed tracking device includes
a housing;
a wireless communication module located at least partially within the housing;
a processing module located at least partially within the housing and communicatively coupled to the wireless communication module;
a power source located at least partially within the housing and electrically coupled to the wireless communication module and the processing module; and
a mailing address of an originator of the parcel assembly, the mailing address being on an exterior surface of the housing, and being configured to enable a recipient of the parcel assembly to return the self-addressed tracking device to the originator of the parcel assembly.

2. The parcel assembly of claim 1, wherein the self-addressed tracking device further comprises an indicator on the exterior surface of the housing that postage for returning the self-addressed tracking device to the originator will be paid by the addressee.

3. The parcel assembly of claim 2, wherein the addressee is the originator of the parcel assembly.

4. The parcel assembly of claim 1, wherein the self-addressed tracking device further comprises postage on the exterior surface of the housing.

5. The parcel assembly of claim 1, wherein the self-addressed tracking device further comprises an indicator on the exterior surface of the housing to return the self-addressed tracking device by depositing it in any mailbox.

6. The parcel assembly of claim 1, wherein the container comprises a box, a carton, a crate, an envelope, or a pouch.

7. The parcel assembly of claim 1, wherein the self-addressed tracking device comprises a satellite navigation system tracking unit.

8. The parcel assembly of claim 6, wherein the satellite navigation system tracking unit comprises a GPS (Global Positioning System) tracking unit or a GLONASS (Global Navigation Satellite System) tracking unit.

9. The parcel assembly of claim 1, further comprising a notice on an outer surface of the container, wherein the notice indicates that the parcel assembly contains an anti-theft device.

10. A self-addressed parcel tracking device, comprising:
a housing;
a wireless communication module located at least partially within the housing;
a processing module located at least partially within the housing and communicatively coupled to the wireless communication module;
a power source located at least partially within the housing and electrically coupled to the wireless communication module and the processing module; and
a mailing address of an originator of a parcel, the mailing address being on an exterior surface of the housing, and being configured to enable a recipient of the parcel to return the self-addressed tracking device to the originator of the parcel.

11. The self-addressed parcel tracking device of claim 10, wherein the self-addressed tracking device further comprises an indicator on the exterior surface of the housing that postage for returning the self-addressed tracking device to the originator will be paid by the addressee.

12. The self-addressed parcel tracking device of claim 11, wherein the addressee is the originator of the parcel assembly.

13. The self-addressed parcel tracking device of claim 10, wherein the self-addressed tracking device further comprises postage on the exterior surface of the housing.

14. The self-addressed parcel tracking device of claim 10, wherein the self-addressed tracking device further comprises an indicator on the exterior surface of the housing to return the self-addressed tracking device by depositing it in any mailbox.

15. The self-addressed parcel tracking device of claim 10, wherein the self-addressed tracking device comprises a satellite navigation system tracking unit.

16. The self-addressed parcel tracking device of claim 15, wherein the satellite navigation system tracking unit comprises a GPS (Global Positioning System) tracking unit or a GLONASS (Global Navigation Satellite System) tracking unit.
